(19) United States
(12) Patent Application Publication
(10) Pub. No.: US 2024/0316671 A1
(43) Pub. Date: Sep. 26, 2024

(54) METHOD FOR DISPLAYING WELDING-RELATED INFORMATION, DISPLAY APPARATUS, WELDING SYSTEM, PROGRAM, AND DISPLAY SCREEN FOR WELDING-RELATED INFORMATION

(71) Applicant: Kabushiki Kaisha Kobe Seiko Sho (Kobe Steel, Ltd.), Kobe-shi (JP)

(72) Inventors: Atsushi FUKUNAGA, Fujisawa-shi (JP); Takeshi KOIKE, Fujisawa-shi (JP)

(73) Assignee: Kabushiki Kaisha Kobe Seiko Sho (Kobe Steel, Ltd.), Kobe-shi (JP)

(21) Appl. No.: 18/577,813

(22) PCT Filed: May 27, 2022
(86) PCT No.: PCT/JP2022/021721

§ 371 Date: Jan. 9, 2024

(30) Foreign Application Priority Data
Jul. 19, 2021 (JP) 2021-118758

(51) Int. Cl. B23K 9/10; B23K 9/095; B23K 9/12

(52) U.S. Cl. CPC B23K 9/10; B23K 9/095; B23K 9/124

(57) ABSTRACT

This welding-related information display method includes a display step for displaying, on the same graph, at least two measurement items from among a plurality of measurement items included in welding-related information, in association with a time series and/or position information. Each of the two or more measurement items is displayed by changing the color and/or the line type on the graph. This method is able to switch between the graph display screen, and a welding video display screen associated with the measurement items displayed on the graph and/or a display screen for historical information about errors detected with the measurement items. The welding-related information includes at least one of welding setting information, welding state information, production status information, correction information, and welding phenomenon information.

### TECHNICAL FIELD

The present invention relates to a method for displaying welding-related information, a display apparatus, a welding system, a program, and a display screen for welding-related information.

### BACKGROUND ART

In gas metal arc welding (hereinafter referred to as GMAW), behavior of various welding phenomena (hereinafter referred to as welding behavior) occurs during the welding. Because some types of welding behavior affect welding quality, such as spatters and fumes, a method for measuring various types of information relating to welding behavior and displaying the information in order to perform real-time monitoring and manage welding quality such as traceability has been desired.

As a conventional display method, PTL 1 discloses a display method that aims to check, in a time series, how time-series data regarding at least welding current or welding voltage and teaching steps of an operation program are related to each other. More specifically, time-series data regarding both welding current and welding voltage obtained during arc welding and an operation program used for the welding are associated with each other, and the teaching steps of the operation program are displayed on a display screen in association with the time-series data using markers.

PTL 2 discloses a display method that aims to improve quality of advanced automated welding operations by promptly detecting information regarding a welding state and sensitively responding to changes in a welding operation environment. More specifically, a method is disclosed where average current, average voltage, average arc short-circuit time, and the like can be collected as status data and buildup, weaving, grooving, welding current, welding voltage, Y-axis control, Z-axis control, and the like can be displayed on a single screen.

### CITATION LIST

### Patent Literature

PTL 1: Japanese Unexamined Patent Application Publication No. 2013-158819
PTL 2: Japanese Unexamined Patent Application Publication No. 9-262670

### SUMMARY OF INVENTION

### Technical Problem

There are, however, a large number of measurement items (hereinafter also referred to simply as items) of information regarding welding behavior and various types of information relating to the welding behavior (hereinafter referred to as welding-related information), and a large number of items need to be monitored in order to solve various problems relating to welding. PTL 1 describes only measurement items relating to current and voltage and is insufficient as information for solving various problems relating to welding. In PTL 2, buildup, weaving, grooving, welding current, welding voltage, Y-axis control, Z-axis control, and the like are displayed on a single screen. Various measurement items, however, are displayed on one graph, and it is difficult to make a comparison for each measurement item. If the plurality of measurement items are displayed on a single screen using different graphs, it is difficult for an operator to promptly recognize information.

The invention in the present application aims to enable an operator to promptly recognize a plurality of pieces of welding-related information and easily obtain useful information in order to solve more advanced problems relating to welding.

### Solution to Problem

The invention in the present application has the following configuration in order to solve the above problems. That is, a method for displaying welding-related information, the method including:
a display step of displaying at least two of a plurality of measurement items included in the welding-related information on a same graph while associating the at least two measurement items with at least a time series or positional information,
in which each of the at least two measurement items is displayed on the graph with a color or a line type of the measurement item changed,
in which a display screen for the graph and at least a display screen for a moving image of welding associated with the measurement items displayed on the graph or a display screen for history information regarding errors detected with respect to the measurement items are switchable, and
in which the welding-related information includes at least welding setting information, welding state information, production condition information, correction information, or welding phenomenon information. (15)

Another mode of the invention in the present application has the following configuration. That is, a display apparatus that displays welding-related information, the display apparatus including:
display means for displaying at least two of a plurality of measurement items included in the welding-related information on a same graph while associating the at least two measurement items with at least a time series or positional information,
in which each of the at least two measurement items is displayed on the graph with a color or a line type of the measurement item changed,
in which a display screen for the graph and at least a display screen for a moving image of welding associated with the measurement items displayed on the graph or a display screen for history information regarding errors detected with respect to the measurement items are switchable, and
in which the welding-related information includes at least welding setting information, welding state information, production condition information, correction information, or welding phenomenon information.

Another mode of the invention in the present application has the following configuration. That is, a welding system including:
a welding apparatus;
a sensor;
a measurement apparatus that measures welding-related information using a value detected by the sensor; and
a display apparatus that displays the welding-related information,
in which the display apparatus includes
display means for displaying at least two of a plurality of measurement items included in the welding-related information on a same graph while associating the at least two measurement items with at least a time series or positional information,
in which each of the at least two measurement items is displayed on the graph with a color or a line type of the measurement item changed,
in which a display screen for the graph and at least a display screen for a moving image of welding associated with the measurement items displayed on the graph or a display screen for history information regarding errors detected with respect to the measurement items are switchable, and
in which the welding-related information includes at least welding setting information, welding state information, production condition information, correction information, or welding phenomenon information.

Another mode of the invention in the present application has the following configuration. That is, a method for displaying deposition-related information, the method including:
a display step of displaying at least two of a plurality of measurement items included in the deposition-related information on a same graph while associating the at least two measurement items with at least a time series or positional information,
in which each of the at least two measurement items is displayed on the graph with a color or a line type of the measurement item changed,
in which a display screen for the graph and at least a display screen for a moving image of deposition associated with the measurement items displayed on the graph or a display screen for history information regarding errors detected with respect to the measurement items are switchable, and
in which the deposition-related information includes at least deposition setting information, deposition state information, production condition information, correction information, or deposition phenomenon information.

Another mode of the invention in the present application has the following configuration. That is, a program causing a computer to perform a process including:
a display step of displaying at least two of a plurality of measurement items included in welding-related information on a same graph while associating the at least two measurement items with at least a time series or positional information,
in which each of the at least two measurement items is displayed on the graph with a color or a line type of the measurement item changed,
in which a display screen for the graph and at least a display screen for a moving image of welding associated with the measurement items displayed on the graph or a display screen for history information regarding errors detected with respect to the measurement items are switchable, and
in which the welding-related information includes at least welding setting information, welding state information, production condition information, correction information, or welding phenomenon information.

Another mode of the invention in the present application has the following configuration. That is, a display screen for welding-related information generated in a display step of displaying at least two of a plurality of measurement items included in the welding-related information on a same graph while associating the at least two measurement items with at least a time series or positional information,
in which each of the at least two measurement items is displayed on the graph with a color or a line type of the measurement item changed,
in which a display screen for the graph and at least a display screen for a moving image of welding associated with the measurement items displayed on the graph or a display screen for history information regarding errors detected with respect to the measurement items are switchable, and
in which the welding-related information includes at least welding setting information, welding state information, production condition information, correction information, or welding phenomenon information.

### Advantageous Effects of Invention

According to the present invention, an operator can promptly recognize a plurality of pieces of welding-related information and easily obtain useful information in order to solve more advanced problems relating to welding.

### BRIEF DESCRIPTION OF DRAWINGS

FIG. 1 is a schematic diagram illustrating an example of the configuration of a welding system according to an embodiment of the invention in the present application.

FIG. 2 is a schematic diagram illustrating an example of the configuration of a robot control apparatus according to the embodiment of the invention in the present application.

FIG. 3 is a schematic diagram illustrating an example of the configuration of a mechanism of a data processing apparatus according to the embodiment of the invention in the present application.

FIG. 4A is a screen diagram illustrating an example of the configuration of a display screen according to the embodiment of the invention in the present application.

FIG. 4B is a screen diagram illustrating an example of the configuration of another display screen according to the embodiment of the invention in the present application.

FIG. 4C is a screen diagram illustrating an example of the configuration of another display screen according to the embodiment of the invention in the present application.

FIG. 4D is a screen diagram illustrating an example of the configuration of another display screen according to the embodiment of the invention in the present application.

FIG. 5A is a screen diagram illustrating an example of the configuration of another display screen according to the embodiment of the invention in the present application.

FIG. 5B is a screen diagram illustrating an example of the configuration of another display screen according to the embodiment of the invention in the present application.

FIG. 6A is a screen diagram illustrating an example of the configuration of another display screen according to the embodiment of the invention in the present application.

FIG. 6B is a screen diagram illustrating an example of the configuration of another display screen according to the embodiment of the invention in the present application.

FIG. 6C is a screen diagram illustrating an example of the configuration of another display screen according to the embodiment of the invention in the present application.

FIG. 7 is a screen diagram illustrating an example of the configuration of another display screen according to the embodiment of the invention in the present application.

FIG. 8 is a flowchart illustrating a process according to the embodiment of the invention in the present application.

FIG. 9 is a diagram illustrating generation of color component images according to the embodiment of the invention in the present application.

FIG. 10 is a flowchart illustrating a process for performing element classification according to the embodiment of the invention in the present application.

FIG. 11 is a diagram illustrating a case where an image includes an obstacle.

FIG. 12 is a diagram illustrating how an image changes according to the embodiment of the invention in the present application.

FIG. 13 is a diagram illustrating how another image changes according to the embodiment of the invention in the present application.

### DESCRIPTION OF EMBODIMENTS

Embodiments for implementing the invention in the present application will be described hereinafter with reference to the drawings and the like. The embodiments that will be described hereinafter are embodiments for describing the invention in the present application and not intended to limit interpretation of the invention in the present application, and not all components described in each embodiment are not necessarily mandatory components for solving problems in the invention in the present application. In the drawings, correspondences between the same components are indicated by giving the same reference numerals.

A method for measuring and displaying welding behavior in the invention in the present application is effective for not only welding but also additive manufacturing utilizing GMAW, or more specifically, wire and arc additive manufacturing (WAAM). The term additive manufacturing is sometimes used in a broad sense as a term layered modeling or rapid prototyping, but the term additive manufacturing is used uniformly in the invention in the present application. When a method according to the invention in the present application is utilized for additive manufacturing, “welding” may be replaced by “deposition”, “additive manufacturing”, “layered modeling”, or the like. For example, “welding behavior” is used in the case of welding, but when the invention in the present application is utilized for additive manufacturing, “deposition behavior” may be used. A “welding system” is used in the case of welding, but when the invention in the present application is utilized for additive manufacturing, an “additive manufacturing system” may be used. Welding and deposition in additive manufacturing are partly different in terms of measurement targets and management targets depending on operation or the like. Items included in “welding-related information”, which will be described later, and items included in “deposition-related information” in additive manufacturing may be accordingly different from each other.

### First Embodiment

An embodiment according to the invention in the present application will be described hereinafter with reference to the drawings.

### [Configuration of Welding System]

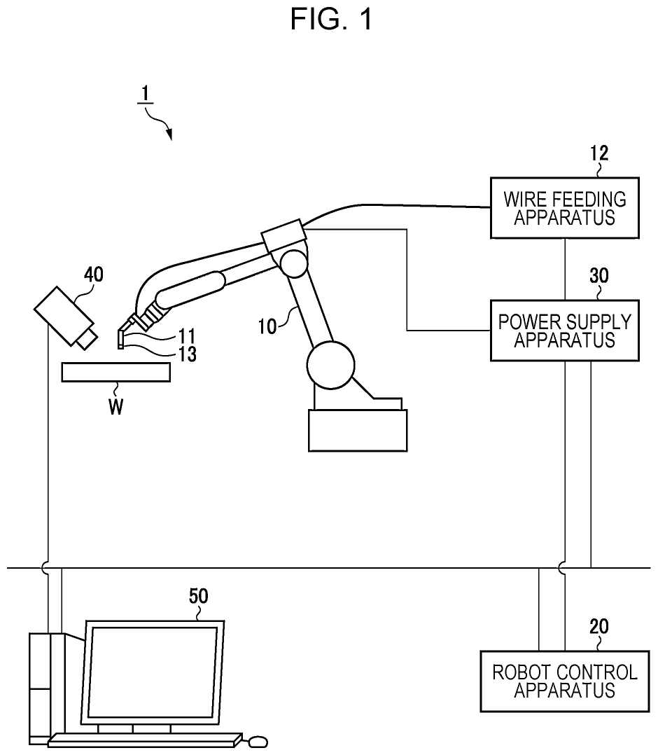

FIG. 1 illustrates an example of the configuration of a welding system 1 according to the present embodiment. The welding system 1 illustrated in FIG. 1 includes a welding robot 10, a robot control apparatus 20, a power supply apparatus 30, a visual sensor 40, and a data processing apparatus 50. When the method according to the invention in the present application is employed for additive manufacturing, for example, the welding system 1 may be replaced by an additive manufacturing system and the welding robot 10 may be replaced by an additive manufacturing robot.

The welding robot 10 illustrated in FIG. 1 is achieved by a six-axis articulated robot, and a welding torch 11 for GMAW is attached to a tip of the welding robot 10. GMAW includes MIG (metal inert gas) welding and MAG (metal active gas) welding, for example, and MAG welding will be taken as an example in the description of the present embodiment. The welding robot 10 is not limited to a six-axis articulated robot, and a portable small robot, for example, may be employed, instead.

A wire feeding apparatus 12 supplies welding wire 13 to the welding torch 11. The welding wire 13 is fed to a welding point from a tip of the welding torch 11. The power supply apparatus 30 supplies power to the welding wire 13. The power results in an arc voltage applied between the welding wire 13 and a workpiece W, thereby generating an arc. The power supply apparatus 30 is provided with a current sensor, which is not illustrated, that detects a welding current (hereinafter referred to as a current) flowing from the welding wire 13 to the workpiece W during welding and a voltage sensor, which is not illustrated, that detects the arc voltage (hereinafter referred to as a voltage) between the welding wire 13 and the workpiece W.

The power supply apparatus 30 includes a processing unit and a storage unit, which are not illustrated. The processing unit is achieved, for example, by a CPU (central processing unit). The storage unit is achieved, for example, by a volatile or nonvolatile memory such as an HDD (hard disk drive), a ROM (read-only memory), or a RAM (random-access memory). The processing unit executes a computer program for controlling a power supply, the computer program being stored in the storage unit, to control the power applied to the welding wire 13. The power supply apparatus 30 is also connected to the wire feeding apparatus 12, and the processing unit controls feed speed and feed volume of the welding wire 13.

Composition and a type of welding wire 13 used differ depending on a welding target. Welding behavior according to the present embodiment includes arc deflection, arc pressure, oxide coverage on a molten pool, a droplet transfer mode, a droplet detachment cycle, the number of short circuits, and occurrence of welding defects such as pits, as well as the above-described spatters and fumes.

The visual sensor 40 is achieved, for example, by a CCD (charge-coupled device) camera. A position where the visual sensor 40 is provided is not particularly limited, and may be directly mounted on the welding robot 10 or fixed at a particular nearby position as a surveillance camera. When the visual sensor 40 is directly mounted on the welding robot 10, the visual sensor 40 moves in accordance with operation of the welding robot 10 in such a way as to shoot an area around the tip of the welding torch 11. A plurality of cameras may be used to achieve the visual sensor 40.

A direction in which the visual sensor 40 shoots is not particularly limited, and when a direction in which welding proceeds is defined as a forward direction, for example, the visual sensor 40 may be provided in such a way as to shoot in the forward direction, a side direction, or a backward direction. A shooting range of the visual sensor 40 may be appropriately determined on the basis of welding behavior of measurement targets. When the targets are spatters and fumes, it is desirable to shoot from the forward direction in order to suppress interference with the welding torch 11.

In the present embodiment, the visual sensor 40 fixed at a particular position is used to capture a moving image as a welding image with a shooting range including at least the workpiece W, the welding wire 13, and the arc. Various shooting settings relating to a welding image may be set in advance or changed in accordance with operation conditions of the welding system 1. The shooting settings include, for example, a frame rate, the number of pixels of an image, resolution, and shutter speed. Although FIG. 1 illustrates the visual sensor 40 as a representative example, other sensors for detecting other types of information may also be provided. For example, the sensors may include a laser sensor. The laser sensor is capable of detecting a groove shape having a gap width or the like before welding, recognizing tracing positions, the amount of weaving correction, and the like on the basis of data regarding the groove shape, and outputting the tracing positions, the amount of weaving correction, and the like as correction information, which will be described later. Details of an example of the sensors according to the present embodiment will be described later, but the number of sensors, positions where the sensors are provided, detection principles, and the like may be changed in accordance with information to be monitored.

The parts of the welding system 1 are communicably connected to one another by one of various wired or wireless communication methods. The number of communication methods used here is not limited to one, and a plurality of communication methods may be combined together for the connection.

### [Configuration of Robot Control Apparatus]

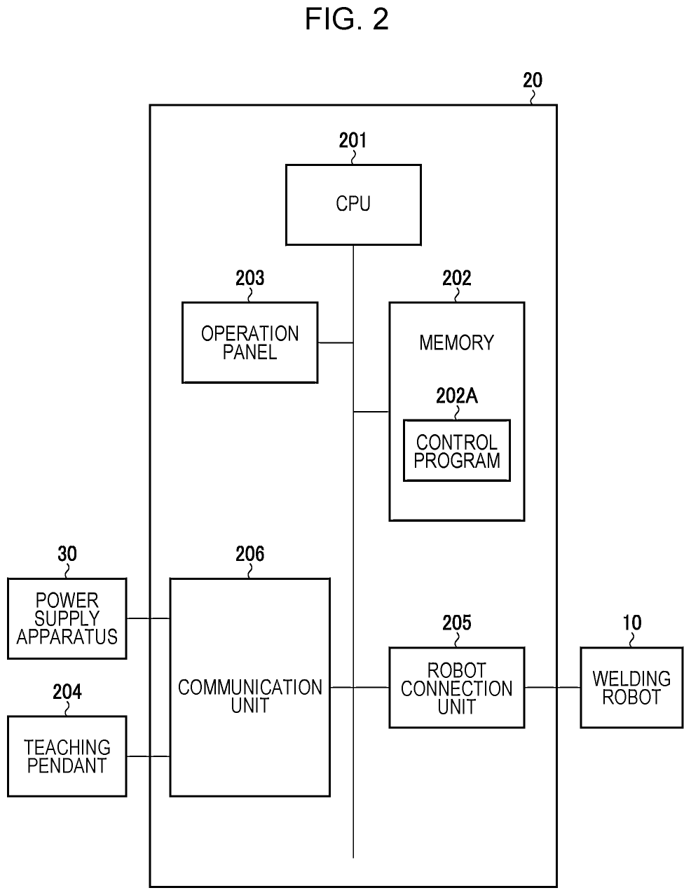

FIG. 2 illustrates an example of the configuration of the robot control apparatus 20 that controls the operation of the welding robot 10. The robot control apparatus 20 includes a CPU 201 that controls the entirety of the robot control apparatus 20, a memory 202 storing data, an operation panel 203 including a plurality of switches, a teaching pendant 204 used for teaching, a robot connection unit 205, and a communication unit 206. The memory 202 is achieved, for example, by a volatile or nonvolatile storage device such as a ROM, a RAM, or an HDD. The memory 202 stores a control program 202A used to control the welding robot 10. The CPU 201 controls various operations performed by the welding robot 10 by executing the control program 202A.

The teaching pendant 204 is mainly used to input instructions to the robot control apparatus 20. The teaching pendant 204 is connected to the robot control apparatus 20 through the communication unit 206. An operator can input a teaching program using the teaching pendant 204. The robot control apparatus 20 controls a welding operation of the welding robot 10 in accordance with the teaching program input from the teaching pendant 204. The teaching program can also be automatically created, for example, on the basis of a CAD (computer-aided design) information or the like using a computer, which is not illustrated. An operation defined by the teaching program is not particularly limited and may differ depending on specifications and a welding method of the welding robot 10. The teaching pendant 204 includes an operation unit and a display unit, which are not illustrated, separately from the operation panel 203 and is capable of displaying display screens, which will be described later.

A driving circuit of the welding robot 10 is connected to the robot connection unit 205. The CPU 201 outputs a control signal based on the control program 202A to the driving circuit, which is not illustrated, of the welding robot 10 through the robot connection unit 205.

The communication unit 206 is a communication module for wired or wireless communication. The communication unit 206 is used to communicate data with the power supply apparatus 30, the data processing apparatus 50, and the teaching pendant 204. A communication method and a communication standard used by the communication unit 206 are not particularly limited, and a plurality of methods may be combined together. The power supply apparatus 30 gives, for example, a current value of the welding current detected by the current sensor, which is not illustrated, and a voltage value of the arc voltage detected by the voltage sensor, which is not illustrated, to the CPU 201 through the communication unit 206.

The robot control apparatus 20 controls axes of the welding robot 10 to control travel speed and an aiming position of the welding torch 11. The robot control apparatus 20 also controls a weaving operation of the welding robot 10 in accordance with a set cycle, amplitude, and welding speed. The weaving operation refers to swinging of the welding torch 11 in a direction intersecting with a direction in which welding proceeds. The robot control apparatus 20 performs weld line tracer control along with the weaving operation. The weld line tracer control is an operation for controlling a left-and-right position relative to a travel direction of the welding torch 11 such that beads are formed along a weld line. The robot control apparatus 20 also controls the wire feeding apparatus 12 through the power supply apparatus 30 to control the feed speed of the welding wire 13 and the like.

### [Configuration of Data Processing Apparatus]

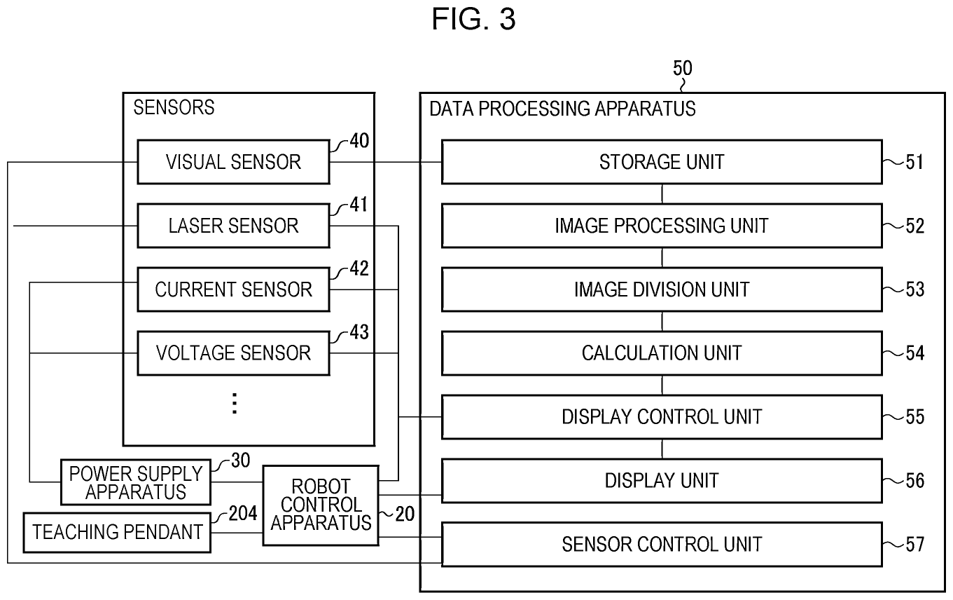

FIG. 3 is a diagram illustrating an example of the functional configuration of the data processing apparatus 50. The data processing apparatus 50 includes, for example, a CPU, a ROM, a RAM, a hard disk device, an input/output interface, a communication interface, and an image output interface, which are not illustrated. In the data processing apparatus 50, the above components operate together to achieve a storage unit 51, an image processing unit 52, an image division unit 53, a calculation unit 54, a display control unit 55, a display unit 56, and a sensor control unit 57. A series of steps performed by the image processing unit 52, the image division unit 53, the calculation unit 54, the display control unit 55, and the display unit 56 may be achieved by software installed on the data processing apparatus 50.

The storage unit 51 stores and manages image data obtained by the visual sensor 40 and provides the image data in accordance with requests from various processing units. The image data herein may be still image data or data regarding a moving image obtained by successively obtaining still image data at any frame rate. The frame rate herein refers to the number of pieces of still image data obtained by the visual sensor 40 at certain time intervals such as, say, one second. The frame rate is preferably within a range of 1 to 10 fps (frames per second). The image data is preferably recorded as a moving image when the image data is utilized for real-time measurement of information regarding welding behavior, that is, welding phenomenon information, and traceability of the welding phenomenon information.

The image processing unit 52 performs preprocessing for performing measurement according to the present embodiment using the image data stored in the storage unit 51. The preprocessing includes, for example, contrast correction, brightness correction, color correction, monochrome image conversion such as binarization, noise reduction, edge enhancement, erosion/dilation, and image feature extraction.

The image division unit 53 creates sub-images obtained by dividing each of predetermined elements into a plurality of images on the basis of processed image data subjected to various types of image processing performed by the image processing unit 52. The predetermined elements include spatters, fumes, and arc light as welding behavior, the welding wire 13 and a nozzle, which are components of the welding system 1, and a base material, a molten pool, obstacles, and other backgrounds. Here, spatters, fumes, and arc light will be particularly focused upon in the following description. Processing performed by the image processing unit 52 is not limited to the preprocessing for the generation of sub-images performed by the image division unit 53. The image processing unit 52 may perform processing on sub-images as necessary.

The calculation unit 54 calculates, on the basis of sub-images and processed image data, various index values for quantitatively measuring spatters, fumes, and arc light as welding behavior. The calculation is preferably performed, for example, in a time series. The time series herein refers to, for example, elapsed time, order specified in a teaching program, order of successive pieces of still image data constituting a moving image, or the like.

The display control unit 55 combines time-series data results corresponding to a plurality of predetermined measurement items as an image using information obtained from the sensors such as the visual sensor 40, a laser sensor 41, a current sensor 42, and a voltage sensor 43, information stored in the robot control apparatus 20 and the like, information calculated by the calculation unit 54, and the like. The display control unit 55 then outputs the image to the display unit 56 or the display unit, which is not illustrated, of the teaching pendant 204. A specific example of the image generated here will be described later.

The display unit 56 displays a screen generated by the display control unit 55. At this time, the display unit 56 synchronizes, for example, values detected by the current sensor 42 and the voltage sensor 43 and various pieces of information obtained from the robot control apparatus 20 in a time series and displays the values and the various pieces of information on a screen. The display unit 56 is achieved, for example, by a liquid crystal display, which is not illustrated, included in the data processing apparatus 50, a display included in the teaching pendant 204, or the like.

The sensor control unit 57 controls operation of the sensors included in the welding system 1. In the example illustrated in FIG. 3, the visual sensor 40, the laser sensor 41, the current sensor 42, the voltage sensor 43, and the like are illustrated as the sensors. The sensor control unit 57 may be configured to control the visual sensor 40 and the laser sensor 41, for example, among the sensors. When the visual sensor 40 is installed on an apparatus other than the welding robot 10, for example, a camera having at least a PTZ function is preferably employed. In this case, the sensor control unit 57 may control pan, tilt, and zoom of the camera in accordance with the operation of the welding robot 10. The sensor control unit 57 may obtain information regarding the operation of the welding robot 10 from the robot control apparatus 20 and control the operation of the visual sensor 40 on the basis of the information. When the laser sensor 41 is provided, the sensor control unit 57 may control a direction, intensity, and a timing of radiation of laser.

### [Display Screens]

Next, examples of the configuration of display screens for various pieces of information according to the present embodiment will be described. In the present embodiment, welding-related information can be displayed on display screens during or after welding. The welding-related information according to the present embodiment includes at least welding setting information such as initial setting values and thresholds, welding state information, production condition information, and correction information, which vary depending on conditions of welding performed on the basis of the setting values, and welding phenomenon information, which is information relating to welding behavior. More specifically, the welding setting information includes a setting value of welding current, a setting value of arc voltage, a setting value of feed speed, a setting value of a shield gas flow rate, and a setting value of shield gas pressure. The welding state information includes a welding current, an arc voltage, a feed speed, a welding speed, a shield gas flow rate, and a level of shield gas pressure that have been detected. The production condition information includes wire consumption, a wire consumption rate, arc percentage, a feed load, and the number of short circuits. The correction information includes the amount of sensing correction and the amount of arc sensor correction (hereinafter also referred to as the amount of tracing). The welding phenomenon information includes spatters, fumes, arc length, arc width, welding defects, molten pool width, molten pool height, and temperature of a molten pool or droplets.

Combinations of measurement items displayed on graphs in display screens that will be described later are examples, and a combination of measurement items is not limited to these. For example, at least two measurement items displayed on a graph are preferably selected from the welding setting information, the welding state information, the production condition information, the correction information, and the welding phenomenon information included in the welding-related information and displayed. It is especially preferable to include a combination highly correlated with occurrence of a certain type of welding behavior. Such a combination may be, for example, a combination of welding current and spatters and a combination of arc voltage and fumes.

An example where welding-related information after welding ends is displayed for a purpose of traceability will be described hereinafter. Information obtained at appropriate times not after welding ends but during the welding, that is, in real-time, may be displayed, instead. Although omitted in FIG. 1, the welding robot 10 according to the present embodiment includes tandem welding torches 11, that is, two welding torch 11. A leading one of the welding torches 11 in a travel direction of the welding torches 11 will also be referred to as a “leading electrode”, and a trailing welding torch 11 that follows the leading electrode will also be referred to as a “trailing electrode”. Leading and trailing can switch in accordance with a direction in which welding proceeds, and the two welding torches 11 play these roles at appropriate times.

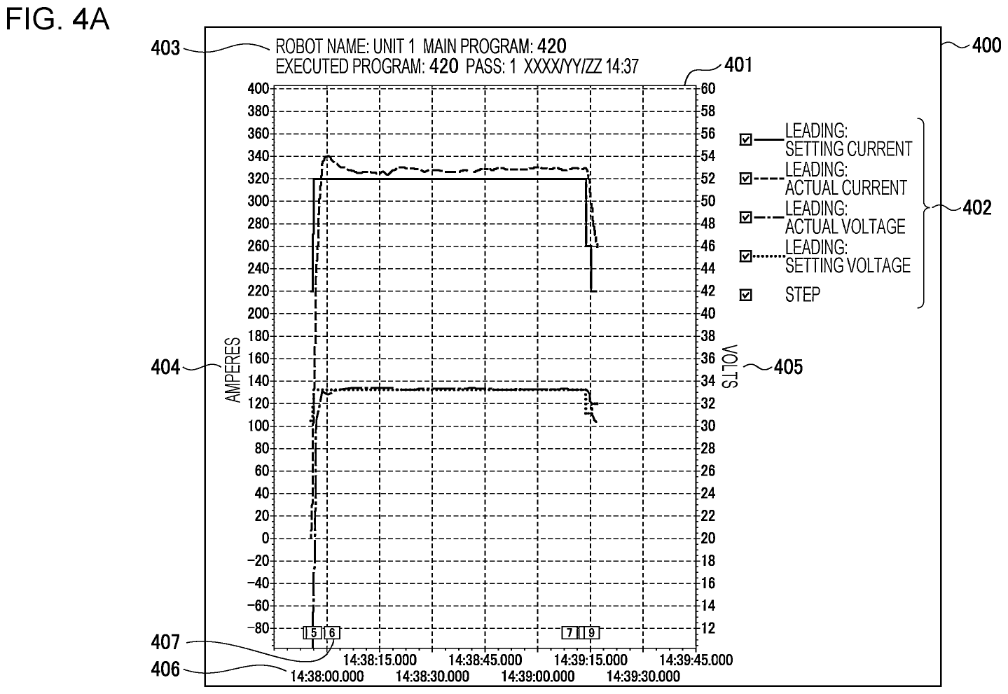

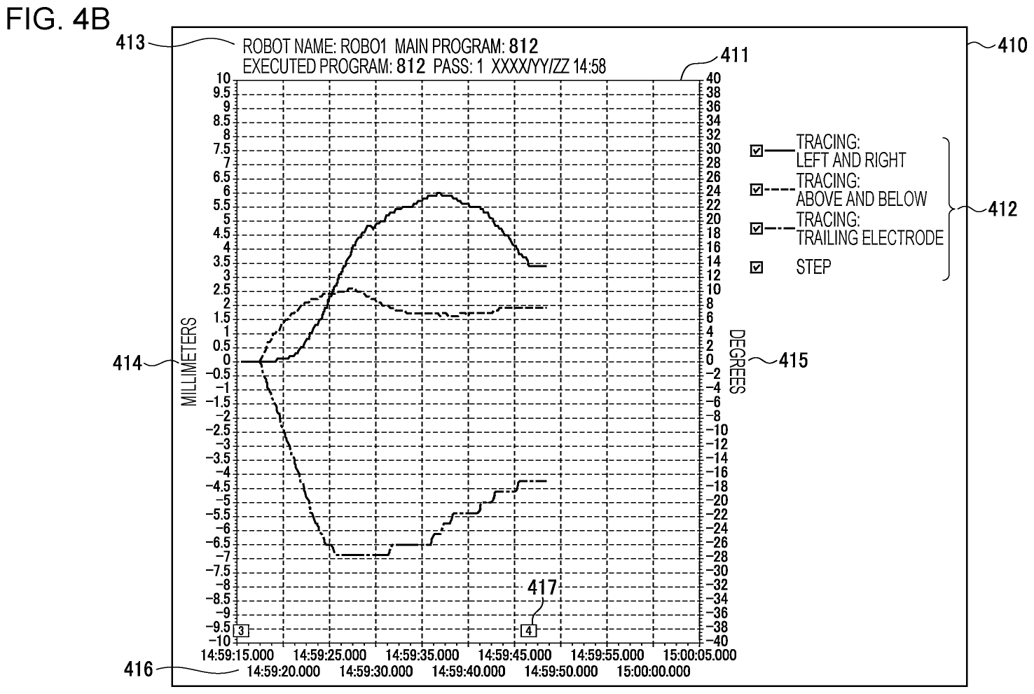

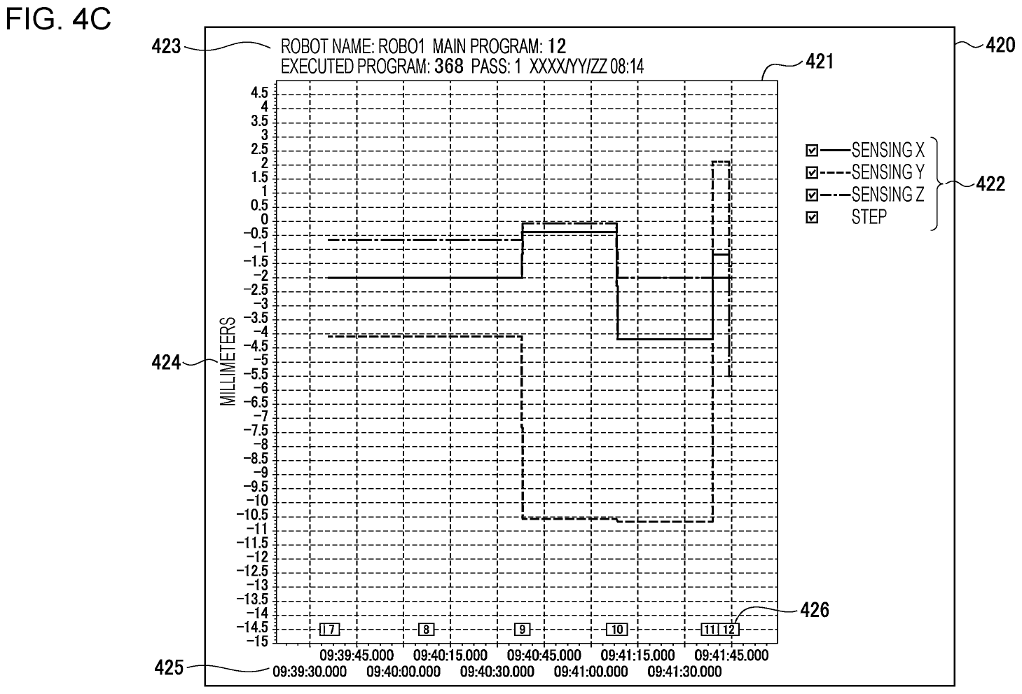

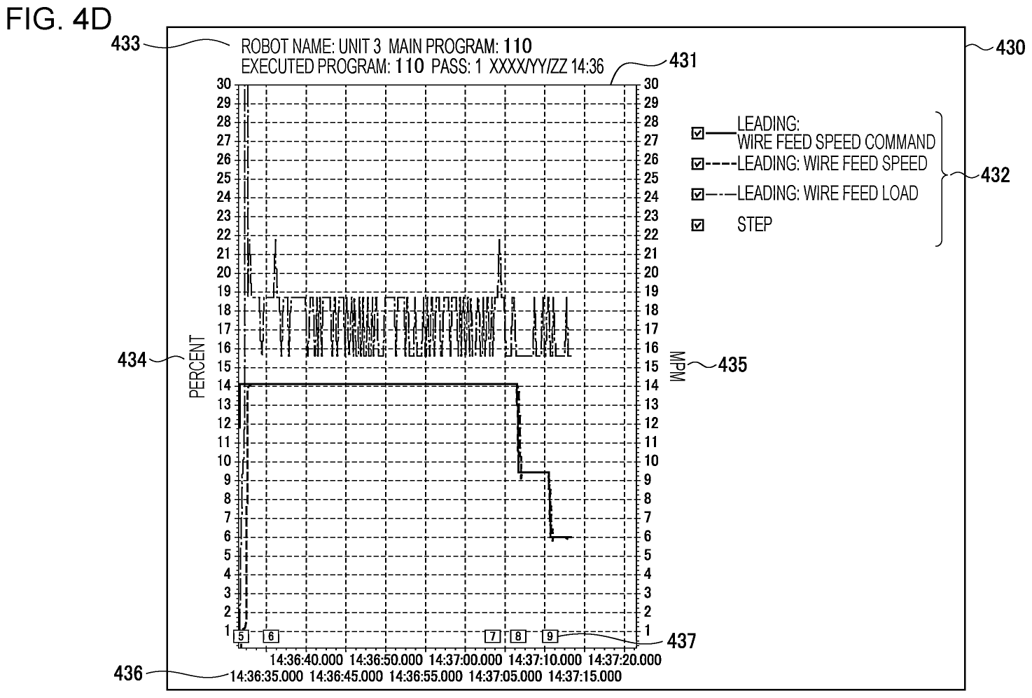

FIG. 4A illustrates an example of the configuration of a display screen 400 according to the present embodiment. The display screen 400 includes a graph area 401, checkboxes 402 for specifying items to be displayed in the graph area 401, and graph information 403 regarding graphs displayed in the graph area 401. In the example illustrated in FIG. 4A, four items, namely “leading: setting current” and “leading: setting voltage”, which indicate setting values of the welding current and the arc voltage, respectively, as the welding setting information, and “leading: actual current” and “leading: actual voltage”, which indicate the welding current and the arc voltage, respectively, as the welding state information, are provided such that these items can be specified with the checkboxes 402. Here, items for the leading electrode are taken as an example. When one or a plurality of items are selected with the checkboxes 402, corresponding graphs are displayed in the graph area 401 in a time series. An item “step” can also be specified with one of the checkboxes 402, and step numbers 407 corresponding to positional information regarding the welding robot 10 are displayed in the graph area 401 by specifying the item.

The graph information 403 may include, for example, information for identifying the welding robot 10, information regarding an executed teaching program, information regarding a weld pass, and time information indicating a time at which welding was performed. In the time information in FIG. 4A and later drawings, “XXXX” indicates year, “YY” indicates month, “ZZ” indicates day, and time is shown thereafter. Order of display and arrangement of these pieces of information are not particularly limited.

Since graphs of current and voltage during welding are displayed in the graph area 401 in the example illustrated in FIG. 4A, corresponding scales are also displayed. A left vertical axis 404 in the graph area 401 has an ampere [A] scale corresponding to current values. A right vertical axis 405 in the graph area 401 has a volt [V] scale corresponding to voltage values. A horizontal axis 406 in the graph area 401 represents time, and time-series graphs are displayed.

Although the vertical axes separately show the scales relating to current and voltage in the example illustrated in FIG. 4A, how scales are displayed are not limited to this. Scales corresponding to a plurality of items may be displayed on one side, instead. Although time and step numbers are displayed along the horizontal axis, other items relating to the time series may be displayed, instead. In order for an operator to perform observation and understand a result of measurement more easily, at least time or step numbers are preferably displayed, and more preferably, both the items are displayed. Upper limits and lower limits of the vertical axes and a display range of time intervals on the horizontal axis may be specified by the operator as desired or specified in advance in accordance with operation conditions of welding or the like.

In the example illustrated in FIG. 4A, the graphs are displayed in the graph area 401 in different display modes so that the graphs can be distinguished from each other. These display modes are examples, and different types or colors of lines may be used to display different graphs. In doing so, the operator can promptly recognize time-series data regarding a plurality of items. In particular, the operator can check at once whether an actual current and an actual voltage have been output as specified with setting values. Since the operator can understand three or more items, that is, a large amount of information, more clearly and easily, a screen where three or more items can be easily identified can be provided.

FIG. 4B illustrates an example of the configuration of a display screen 410 according to the present embodiment. A basic configuration is the same as that of the display screen 400 illustrated in FIG. 4A, but the display screen 410 handles the amount of control relating to tracer control based on a weld line, that is, the amount of tracing. An arc sensor is generally used for the amount of tracing, but another sensor such as a laser sensor may be used to detect the amount of tracing, instead. The display screen 410 includes a graph area 411, checkboxes 412 for specifying items to be displayed in the graph area 411, and graph information 413 regarding graphs displayed in the graph area 411. In the example illustrated in FIG. 4B, three items, namely “tracing: left and right”, which indicates the amount of tracing to the left and right of a weld line of the leading electrode, “tracing: above and below”, which indicates the amount of tracing above and below the weld line of the leading electrode, and “tracing: trailing electrode”, which indicates the amount of rotation for tracing by the trailing electrode, are provided such that these items can be specified with the checkboxes 412. An item “step” can also be specified with one of the checkboxes 412, and step numbers 417 are displayed in the graph area 411 by specifying the item.

The graph information 413 may include, as with the graph information 403 in the display screen 400 illustrated in FIG. 4A, for example, the information for identifying the welding robot 10, information regarding an executed teaching program, information regarding a weld pass, and time information indicating a time at which welding was performed.

Since graphs of the amount of tracing above, below, to the left of, and to the right of the weld line by the leading electrode and the rotation for the tracing by the trailing electrode are displayed in the graph area 411 in the example illustrated in FIG. 4B, corresponding scales are also displayed. A left vertical axis 414 in the graph area 411 has a millimeter [mm] scale corresponding to the amount of tracing above, below, to the left of, and to the right of the weld line. A left vertical axis 415 in the graph area 411 has a degree [°] scale corresponding to a rotation angle. A horizontal axis 416 in the graph area 411 represents time, and time-series graphs are displayed.

FIG. 4C illustrates an example of the configuration of a display screen 420 according to the present embodiment. A basic configuration is the same as that of the display screen 400 illustrated in FIG. 4A, but the display screen 420 handles the amount of correction of a welding position through touch sensing. The touch sensing need not be performed, and laser sensing, for example, may be performed, instead. The display screen 420 includes a graph area 421, checkboxes 422 for specifying items to be displayed in the graph area 421, and graph information 423 regarding items displayed in the graph area 421. In the example illustrated in FIG. 4C, three items corresponding to axes of a XYZ three-dimensional coordinate system defined in advance are provided such that these items can be specified with the checkboxes 422. An item “step” can also be specified with one of the checkboxes 422, and step numbers 426 are displayed in the graph area 421 by specifying the item.

The graph information 423 may include, as with the graph information 403 in the display screen 400 illustrated in FIG. 4A, for example, the information for identifying the welding robot 10, information regarding an executed teaching program, information regarding a weld pass, and time information indicating a time at which welding was performed.

Since the graphs of the amount of correction corresponding to the axes are displayed in the graph area 421 in the example illustrated in FIG. 4C, corresponding scales are also displayed. A left vertical axis 424 in the graph area 421 has a millimeter [mm] scale corresponding to the amount of correction. A horizontal axis 425 in the graph area 421 represents time, and time-series graphs are displayed.

FIG. 4D illustrates an example of the configuration of a display screen 430 according to the present embodiment. A basic configuration is the same as that of the display screen 400 illustrated in FIG. 4A, but the display screen 430 handles information relating to feeding of welding wire performed by the wire feeding apparatus 12. The display screen 430 includes a graph area 431, checkboxes 432 for specifying items to be displayed in the graph area 431, and graph information 433 regarding graphs displayed in the graph area 431. In the example illustrated in FIG. 4D, three items, namely a command value (a command value may be hereinafter referred to as a setting value) of feed speed of welding wire for the leading electrode as the welding setting information and an actual feed speed and a wire feed load as the welding state information, are provided such that these items can be specified with the checkboxes 432. An item “step” can also be specified with one of the checkboxes 432, and step numbers 437 are displayed in the graph area 431 by specifying the item.

The graph information 433 may include, as with the graph information 403 in the display screen 400 illustrated in FIG. 4A, for example, the information for identifying the welding robot 10, information regarding an executed teaching program, information regarding a weld pass, and time information indicating a time at which welding was performed.

Since the graphs of the feed speed and the feed load of welding wire are displayed in the graph area 421 in the example illustrated in FIG. 4D, corresponding scales are also displayed. A left vertical axis 434 in the graph area 431 has a percent [%] scale corresponding to the feed load. A left vertical axis 435 in the graph area 431 has an MPM [m/m] scale corresponding to the feed speed. A horizontal axis 436 in the graph area 431 represents time, and time-series graphs are displayed.

### (Display of Error Check Results)

The data processing apparatus 50 according to the present embodiment performs various error checks on the basis of obtained information and displays results on display screens. The display screens relating to the error checks will be described hereinafter.

First, the error checks according to the present embodiment will be described. In the present embodiment, three error checks for a setting value error, a reference value error, and an absolute value error are performed. These error checks are examples, and only a subset of these may be performed or other error checks may also be performed.

In the setting value error check, if a difference between a setting value and a measured value, that is, a feedback value, remains larger than an allowable range, that is, a threshold, for a certain period of time, it is determined that a setting value error has occurred. Current [A], voltage [V], welding speed [cm/min], wire feed speed [m/min], weaving width [mm], and the like are checked for a setting value error.

In the reference value error check, reference values and feedback values are each averaged in a certain time unit, and if a difference between averages exceeds an allowable range, that is, a threshold, it is determined that a reference value error has occurred. Here, the reference values may be, for example, measured values at a time when a desirable welding result was obtained. Current [A], voltage [V], wire feed speed [m/min], weaving width [mm], and the like are checked for a reference value error.

In the absolute value error check, if a feedback value deviates from allowable upper and lower limit values for a certain period of time, it is determined that an absolute value error has occurred. A wire feed load [%], heat input [J/cm], and the like are checked for an absolute value error.

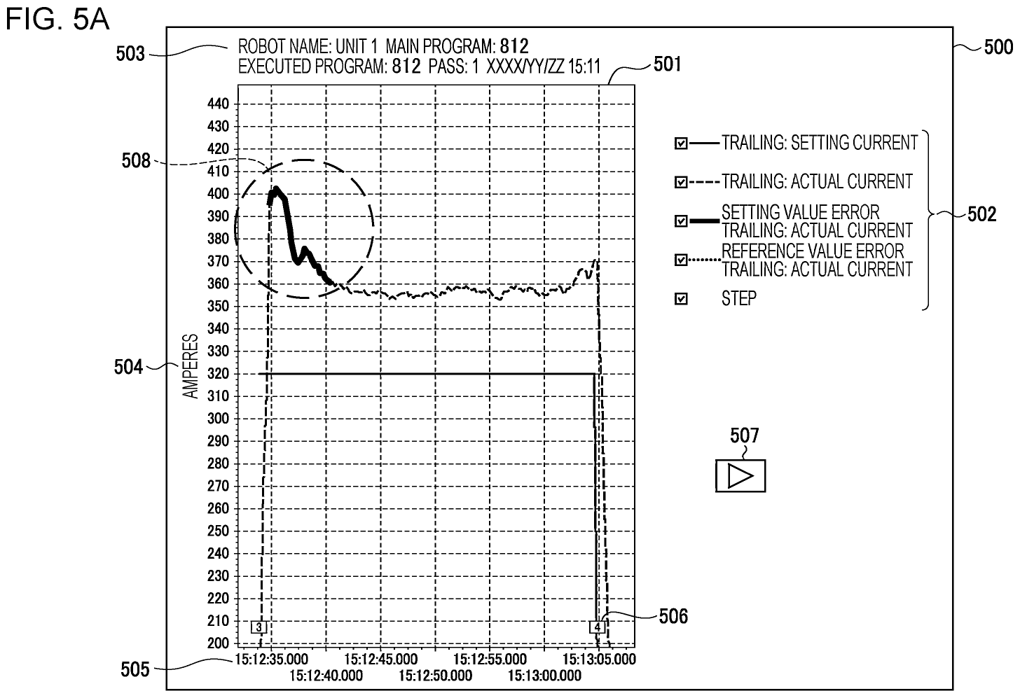

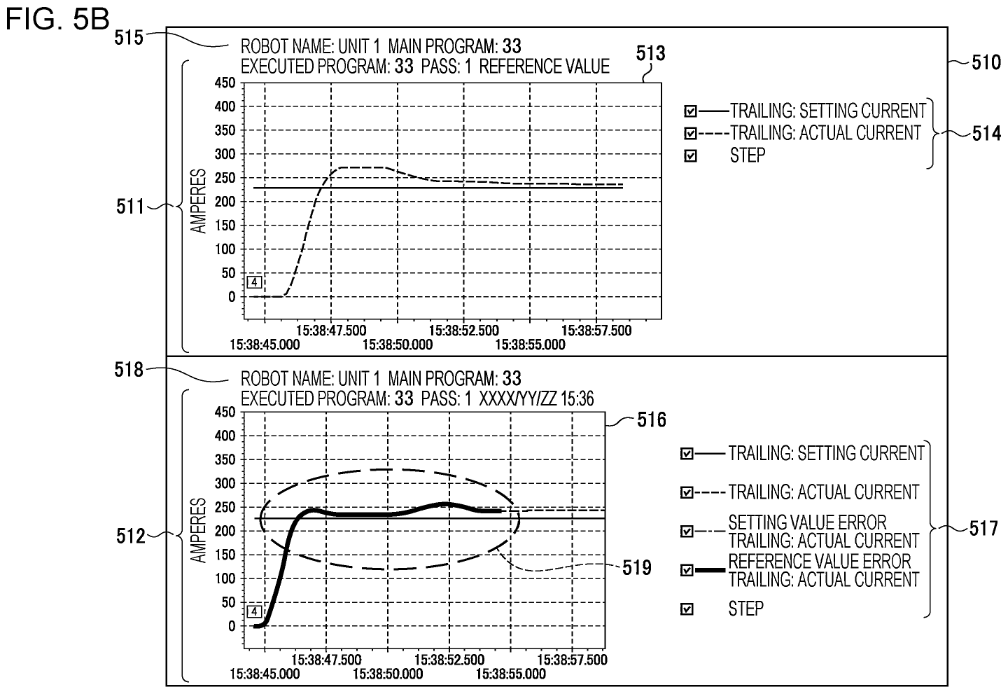

FIG. 5A illustrates an example of the configuration of a display screen 500 based on error check results according to the present embodiment. Here, a screen for displaying check results of a setting value error and a reference value error for current is illustrated. The display screen 500 includes a graph area 501, checkboxes 502 for specifying items to be displayed in the graph area 501, graph information 503 regarding graphs displayed in the graph area 501, and a transition button 507. In the example illustrated in FIG. 5A, four items, namely “trailing: setting current”, which indicates a setting value of welding current as the welding setting information, “trailing: actual current”, which indicates welding current as the welding state information, “setting value error trailing: actual current”, which indicates a point identified as a setting value error, and “reference value error trailing: actual current”, which indicates a point identified as a reference value error, are provided such that these items can be specified with the checkboxes 502. Here, items for the trailing electrode are taken as an example. If one or a plurality of items are selected from the checkboxes 502, corresponding graphs are displayed in the graph area 401 in a time series. An item “step” can also be specified with one of the checkboxes 502, and step numbers 506 corresponding to the positional information regarding the welding robot 10 are displayed in the graph area 501 by specifying the item.

The graph information 403 may include, for example, the information for identifying the welding robot 10, information regarding an executed teaching program, information regarding a weld pass, and time information indicating a time at which welding was performed.

Since a graph of current in welding is displayed in the graph area 501 in the example illustrated in FIG. 5A, a corresponding scale is also displayed. A left vertical axis 504 in the graph area 501 has an ampere [A] scale corresponding to current values. A horizontal axis 505 in the graph area 501 represents time, and a time series graph is displayed.

A range indicated by a broken line 508 is a range of actual current where it has been determined that a setting value error has occurred. That is, this is a point at which a difference between setting current and actual current remained larger than a certain threshold for a certain period of time. The transition button 507 is a button for transitioning to a display screen 510 illustrated in FIG. 5B.

FIG. 5B illustrates an example of the configuration of the display screen 510, which corresponds to the display screen 500 illustrated in FIG. 5B, based on error check results according to the present embodiment. Here, an example of the configuration of a screen for displaying check results of a setting value error and a reference value error for current is illustrated. The display screen 510 is roughly divided into two areas 511 and 512. The area 511 includes a graph area 513, checkboxes 514 for specifying items to be displayed in the graph area 513, and graph information 515 regarding graphs displayed in the graph area 513. Two items, namely “trailing: setting current”, which indicates a setting value of welding current as the welding setting information, and “trailing: actual current”, which indicates welding current as the welding state information, are provided such that these items can be specified with the checkboxes 514. Here, items for the trailing electrode are taken as an example. If one or a plurality of items are selected from the checkboxes 514, corresponding graphs are displayed in the graph area 513 in a time series. If “trailing: actual current” is specified with a corresponding one of the checkboxes 514, a graph of reference values used for the reference value error check is displayed. An item “step” can also be specified with one of the checkboxes 514, and step numbers corresponding to the positional information regarding the welding robot 10 are displayed in the graph area 513 by specifying the item.

The area 512 includes a graph area 516, checkboxes 517 for specifying items to be displayed in the graph area 516, and graph information 518 regarding graphs displayed in the graph area 516. Four items, namely “trailing: setting current”, which indicates a setting value of welding current as the welding setting information, “trailing: actual current”, which indicates welding current as the welding state information, “setting value error trailing: actual current”, which indicates a point identified as a setting value error, and “reference value error trailing: actual current”, which indicates a point identified as a reference value error, are provided such that these items can be specified with the checkboxes 517. Here, items for the trailing electrode are taken as an example. If one or a plurality of items are selected from the checkboxes 517, corresponding graphs are displayed in the graph area 516 in a time series. An item “step” can also be specified with one of the checkboxes 514, and step numbers corresponding to the positional information regarding the welding robot 10 are displayed in the graph area 516 by specifying the item.

A range indicated by a broken line 519 is a range of actual current identified as a reference value error. That is, this is a point where reference values and feedback values are each averaged in a certain time unit and a difference between averages has exceeded an allowable range, that is, a threshold.

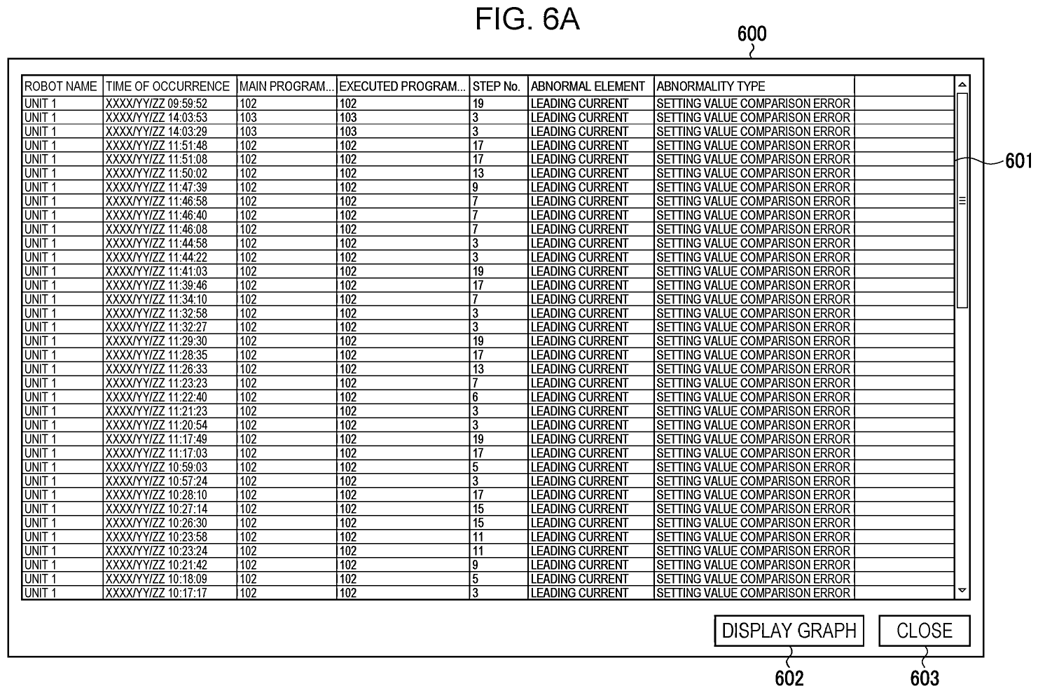

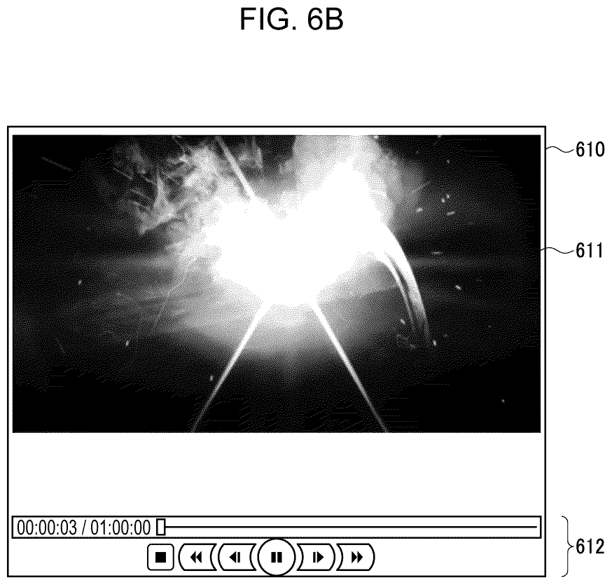

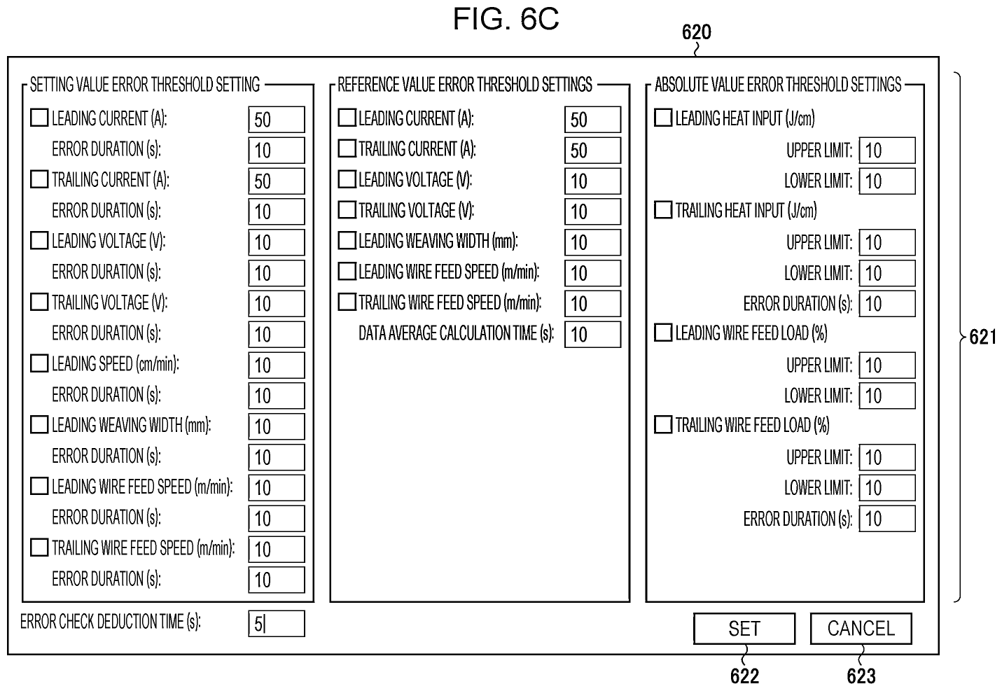

In the present embodiment, the display screen 500 and the display screen 510 can transition to another display screen. FIG. 6A illustrates an example of the configuration of a list screen 600 indicating history information 601 regarding errors. When a point identified as an error is displayed as a graph in the display screen 500, for example, the list screen 600 may be displayed by selecting a corresponding range. The history information is stored, at an appropriate time, in the storage unit 51 or the like each time an error has been identified. Items included in the history information 601 are examples, and items other than those illustrated in FIG. 6A may also be included. When a graph display button 602 is pressed, a previous screen, that is, the display screen 500, for example, is displayed. If a close button 603 is pressed, the list screen 600 is closed.

FIG. 6B illustrates an example of the configuration of a display screen 610 for playing back a moving image held in association with history information at a time when an error was identified. When a point identified as an error is displayed as a graph in the display screen 500, for example, the display screen 610 may be displayed, by selecting any position, in order to play back a moving image corresponding to the position. Alternatively, the display screen 610 may be displayed, by selecting any error in the history information 601 included in the list screen 600 illustrated in FIG. 6A, in order to play back a moving image corresponding to the error. A display area 611 is an area where a moving image is played back. In an operation area 612, various operation icons for receiving operations during playback of a moving image. The operation icons may be ones corresponding to operations performed on a moving image, such as play, stop, fast forward, and rewind, but are not particularly limited.

FIG. 6C illustrates an example of the configuration of a setting screen 620 for making settings for various types of error identification according to the present embodiment. Setting items 621 include items for setting various thresholds and setting values used to check the above-described setting value error, reference value error, and absolute value error. These items are examples, and more or fewer items may be used depending on types of error checks. If a set button 622 is pressed, the setting is completed with values input to the setting items 621. If a cancel button 623 is pressed, the setting is aborted, and the screen is closed.

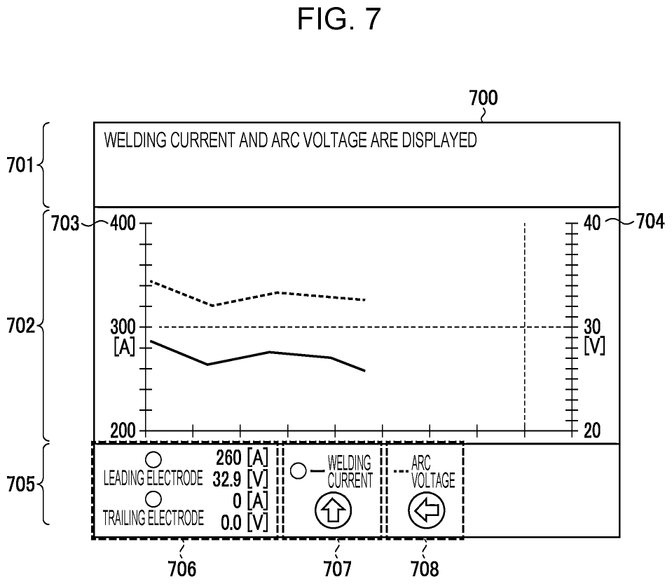

As described with reference to FIGS. 2 and 3, the system according to the present embodiment includes a plurality of parts capable of displaying information, such as the display unit 56 of the data processing apparatus 50 and the display unit of the teaching pendant 204. The configuration of a screen to be displayed may therefore be different depending on the part to display the screen. Here, another configuration of a screen that can be displayed by the teaching pendant 204, for example, will be described. FIG. 7 illustrates another example of the configuration of a display screen.

A display screen 700 includes display areas 701, 702, and 705. The display area 701 displays an outline of information displayed in the display areas 702 and 705 and related information. The display area 702 displays various time-series graphs. Here, graphs of welding current and arc current as measured values are displayed. A left vertical axis 703 in the display area 702 has an ampere [A] scale corresponding to current, and a left vertical axis 704 has a volt [V] scale corresponding to voltage. The scales change depending on graphs to be displayed.

The display area 705 displays detailed information relating to the graphs displayed in the display area 702. Here, the display area 705 displays three pieces of information 706, 707, and 708 as an example. The information 706 indicates current values and voltage values of the leading electrode and the trailing electrode at a present time, that is, a time point corresponding to ends of the graphs displayed in the display area 702. The information 707 indicates a fluctuation trend of welding current at the present time with an arrow icon. The information 708 indicates a fluctuation trend of arc voltage at the present time. A fluctuation trend may be indicated, for example, by an icon with which whether a value is increasing from, decreasing from, the same as, that is, not changing from, a previous value in position or time can be easily recognized visually. More specifically, an upward arrow indicates that a graph is changing upward, and a downward arrow indicates that a graph is changing downward. A sign or a figure used for the icon is not particularly limited. The amount of change can be identified with size, a color, or a tone of the arrow. In the case of time-series data regarding the amount of arc sensor correction, for example, a green arrow may indicate a change smaller than 1 mm, a yellow arrow may indicate a change larger than or equal to 1 mm and smaller than 2 mm, and a red arrow may indicate a change larger than or equal to 2 mm.

Whether a value in a graph is increasing or decreasing may be evaluated on the basis of any sampling point in observation time or position and at least two nearby points. A linear model of a linear equation, for example, may be created from the sampling point in observation time or position and the at least two nearby points, and an increase or a decrease can be identified on the basis of a slope of the linear model. Nearby herein may be defined in advance as within a certain number of points or a certain period of time from any sampling point in observation time or position. For example, sampling intervals may be 0.2 second, and a display screen, that is, a graph, may be updated at intervals of 1 second. An increase or a decrease, too, may be evaluated at intervals of 1 second in accordance with the update of the graph.

### [Example of Analysis]

As illustrated in FIGS. 6A and 6B, a measured value and any value, namely a reference value or a past value, for example, can be compared with each other, an error is checked, and a display screen according to the present embodiment can present information with which a result of the check can be easily recognized. When the measured value is that of welding current, the measured value can be compared with a past value or a setting value, and a position identified as an error can be extracted. When the measured value is that of spatters or fumes, a point where spatters or fumes occur more frequently than a standard value can be identified on the basis of reference data, and the operator can also easily recognize and analyze specific defects such as spatters or fumes by comparing the defects with another item such as welding current. It is therefore more preferable to display, in a display screen, the welding phenomenon information and at least one of other pieces of information while associating the welding phenomenon information and the at least one of other pieces of information with each other, and it is even more preferable to display, among the other pieces of information, at least the welding state information and the welding phenomenon information while associating the welding state information and the welding phenomenon information with each other.

The operator can therefore obtain more accurate information by displaying at least the welding phenomenon information. The operator can switch between the display screens illustrated in FIGS. 5A, 5B, and 6B and, when items include a setting value and a measured value of welding current and spatters, easily recognize how greatly spatters have increased by referring to these display screens using a difference between the setting value and the measured value of the welding current as a measure of defects. When items include a setting value and a measured value of a gas flow rate and pits as welding defects, insufficient supply of gas can be identified on the basis of a difference between the setting value and the measured value of the gas flow rate, and the operator can recognize presence of absence of occurrence of welding defects or the number of defects during a period of the insufficient supply of gas. The operator can thus easily understand welding behavior and a cause of the welding behavior.

A method for measuring spatters, fumes, and arc light and obtaining indices of the spatters, the fumes, and the arc light will be described hereinafter as an example of information that can be displayed in a display screen according to the present embodiment. A method for displaying measured indices in a display screen may be adjusted at an appropriate time on the basis of the above configurations.

### [Measurement Method]

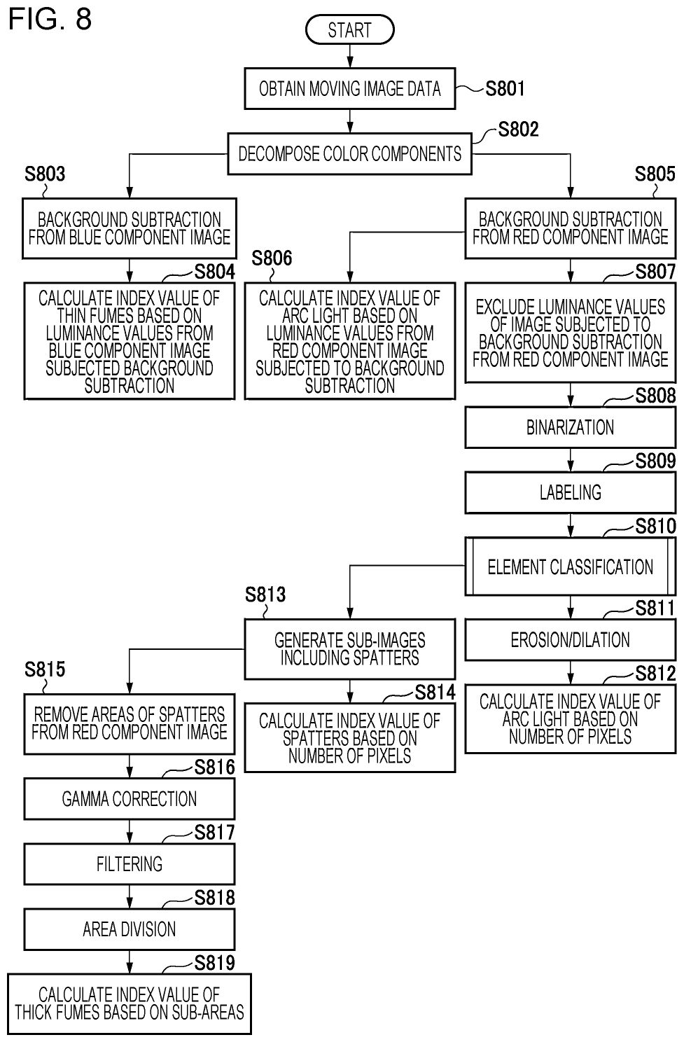

FIG. 8 is a diagram illustrating a process for measuring a plurality of types of welding behavior from image data. Although FIG. 8 illustrates a process for measuring spatters, fumes, and arc light, which are examples of welding behavior, not all of these need to be measured, and only a subset of these may be measured, instead. In addition, although a plurality of index values are calculated for one type of welding behavior in FIG. 8, not all the plurality of index values need to be calculated, and one index value may be calculated for one type of welding behavior. The present embodiment is an example where moving image data after welding ends is processed for the purpose of traceability, but the following process need not necessarily be performed after welding ends and may be performed in parallel with the welding, that is, in real-time.

A processing flow illustrated in FIG. 8 may be achieved by reading and executing a program stored in the storage unit using the processing unit of the data processing apparatus 50 and causing the parts illustrated in FIG. 3 to function when welding behavior is measured in parallel with welding or using an image captured during the welding.

In S801, the data processing apparatus 50 obtains moving image data to be processed. Here, shooting conditions including a frame rate and shutter speed are set to the visual sensor 40, and a range of welding positions to be shot by the visual sensor 40 is obtained as moving image data. The shooting conditions may be set to any values by the operator or may be fixed values defined in advance. The obtained moving image data may be directly stored in the storage unit 51 of the data processing apparatus 50 or, when the visual sensor 40 includes a memory, temporarily stored in the memory of the visual sensor 40 and transferred to the storage unit 51. The following process is performed for each of a plurality of pieces of still image data included in the moving image data.

In S802, the data processing apparatus 50 performs color component decomposition on the obtained moving image data. The moving image data according to the present embodiment includes, for example, color images whose pixels are based on RGB signals indicating color components of red, green, and blue. Each color component of an RGB signal is represented by 8 bits, and a pixel is represented by a total of 24 bits. In this case, a signal value corresponding to each color component takes a value of 0 to 255. In color component decomposition, each color component is focused upon, and moving image data where RGB color components are distinguished from one another is created. In other words, moving image data only for an R color component, moving image data only for a G color component, and moving image data only for a B color component are extracted and generated from moving image data. More specifically, when moving image data only for an R color component is generated, signal values of G and B in moving image data are set to 0 to perform the color component decomposition.

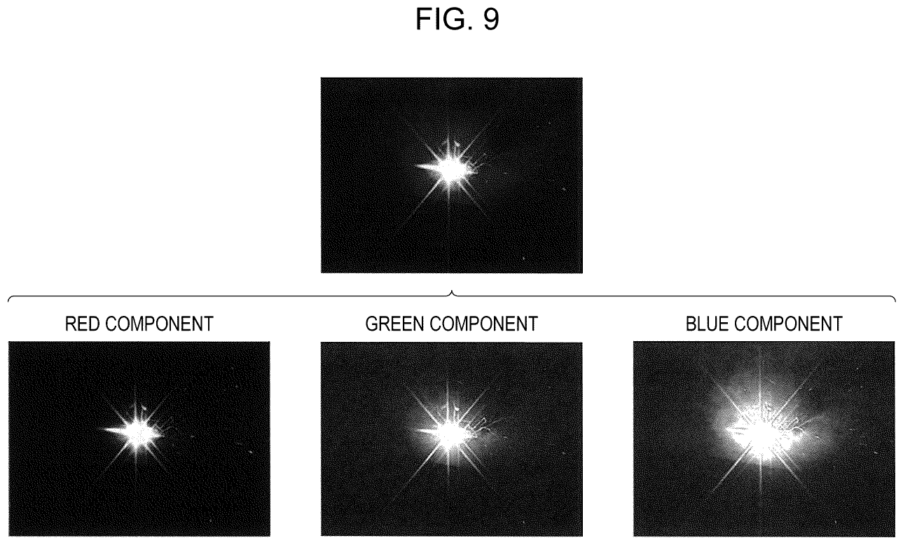

FIG. 9 is a diagram illustrating generation of moving image data for RGB color components from moving image data. As illustrated in FIG. 9, still image data for the three color components generated from still image data included in moving image data has different expressions and captures different features from the same type of welding behavior. Still image data only for the R color component, still image data only for the G color component, and still image data only for the B color component will be referred to as a “red component image”, a “green component image”, and a “blue component image” in the following description.

The inventor in the present application has found as a result of experiments and examinations that thermal energy light can be clearly observed in the blue component image. Thermal energy light is an event relating to arc light or fumes. That is, pale light of thermal energy light can be extracted using the blue component image, and diffused fumes, which have been difficult to extract, can be calculated on the basis of the pale light.

In addition, the inventor in the present application has found as a result of experiments and examinations that high-temperature luminescence of metals, slag, and the like can be clearly observed in the red component image. That is, spatters, a molten pool, or fumes with high particle density can be detected on the basis of high-temperature luminescence using the red component image. Fumes with high particle density in an image will be referred to as “thick fumes”, and fumes with low particle density will be referred to as “thin fumes” hereinafter. The thickness is a relative concept, and density values are not limited.

By performing a process for obtaining RGB components through decomposition, features of various types of welding behavior can be easily extracted. In the present embodiment, an example where welding behavior is measured using the red component image and the blue component image will be described. How to measure welding behavior, however, is not limited to this, and welding behavior may be measured using the green component image as well. The green component image may be used, for example, in area identification of elements, which will be described later.

Although an RGB color space is taken as an example in the present embodiment, a color space used is not limited to this. For example, another color space capable of performing conversion for RGB parameters may be used, instead. More specifically, available color spaces include RGBA, YCbCr, and YUV.

First, calculation of an index value for measuring thin fumes using the blue component image will be described. In S803, the data processing apparatus 50 employs background subtraction on the blue component image using the image processing unit 52. A method of the background subtraction is not particularly limited, but the background subtraction may be performed by removing noise using a known rolling ball algorithm. The background subtraction may be performed through filtering based on a certain filter. As a result of the processing in this step, spike signals can be removed, and pixel values that vary smoothly can be obtained. In the present embodiment, the pixel values that vary smoothly are assumed to be derived from thin fumes.

In S804, the data processing apparatus 50 calculates, using the calculation unit 54, a total value of luminance as the index value of thin fumes in the blue component image subjected to the background subtraction in S803. Here, a total value weighted on the basis of luminance values in a luminance histogram based on the entirety of the blue component image may be calculated as the index value.

Next, index values for measuring arc light and thick fumes using the red component image will be described. In S805, the data processing apparatus 50 employs background subtraction for the red component image using the image processing unit 52. A method of background removal is not particularly limited, but the background subtraction may be performed, for example, by removing noise using a known rolling ball algorithm as in the processing in S803. The background subtraction may be performed through filtering based on a certain filter, instead. As a result of the processing in this step, spike signal can be removed, and pixel values that vary smoothly can be obtained.

In S806, the data processing apparatus 50 calculates a total value of luminance as the index value of arc light in the red component image subjected to the background subtraction in S805 performed by the calculation unit 54. Here, a total value weighted on the basis of luminance values in a luminance histogram based on the entirety of the red component image may be calculated as the index value.

In S807, the data processing apparatus 50 excludes, using the image processing unit 52, luminance values of the red component image subjected to the background subtraction generated in S805 from luminance values of pixels of the red component image generated in S802. As a result of this step, pixel values that vary smoothly can be excluded.

In S808, the data processing apparatus 50 binarizes, using the image processing unit 52, the red component image processed in S807 to generate a binary image. A method of binarization is not particularly limited, and a known method may be used. Setting of a threshold for the binarization is not particularly limited, either, and a median of possible pixel values may be determined as the threshold.

In S809, the data processing apparatus 50 labels, using the image processing unit 52 and the binary image generated in S808, areas included in the binary image. The binary image includes a plurality of areas, each of which includes one or more pixels, and these areas are extracted. In the present embodiment, areas of the binary image consisting of pixels whose pixel values are “1” are labeled as areas corresponding to elements caused by welding behavior. A method of labeling is not particularly limited, and a known method may be used. A lower limit of size of each area is not particularly limited, either, and a smallest area may consist of, for example, one pixel. When areas consisting of pixels whose pixel values are “0” correspond to elements caused by welding behavior, such areas may be labeled.

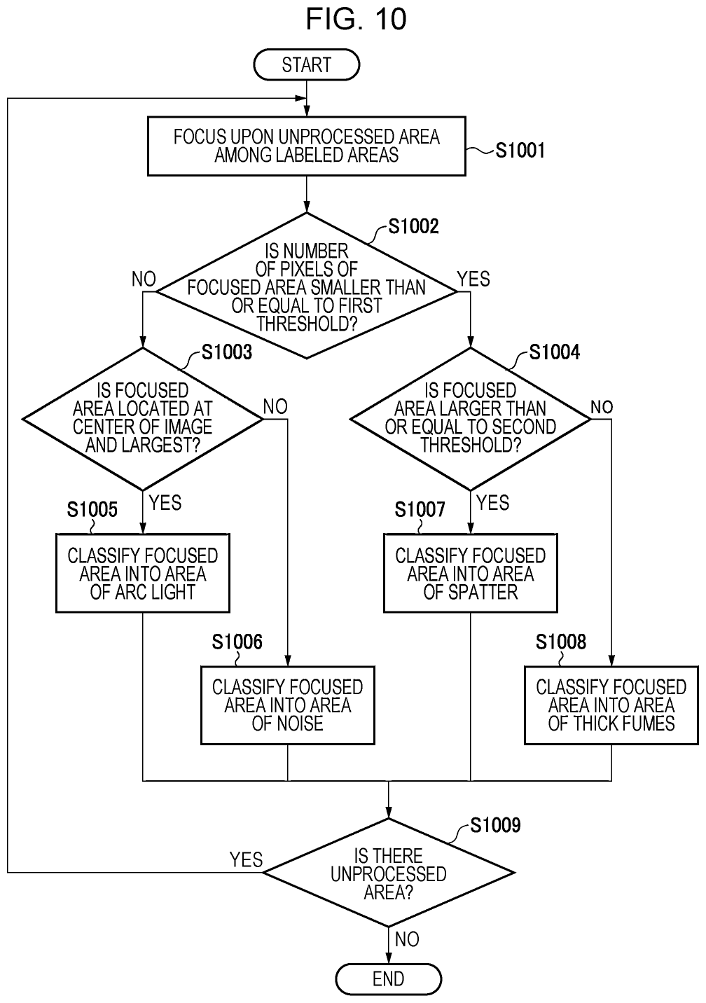

In S810, the data processing apparatus 50 performs, using the image division unit 53, element classification on the areas of the image labeled in S809. Details of this step will be described with reference to FIG. 10. This step is performed for each of the areas on the basis of a result of the labeling performed using each of a plurality of red component images to be processed.

In S1001, the image division unit 53 focuses upon an unprocessed area among the one or plurality of labeled areas included in the binary image. At this time, order of focusing is not particularly limited, but the labeled areas may be sorted in descending order of the size, and the image division unit 53 may focus upon the labeled areas in descending order of the size.

In S1002, the image division unit 53 determines whether the number of pixels included in the focused area is smaller than or equal to a first threshold. It is assumed here that the first threshold is 300 pixels. The first threshold may be set in accordance with overall size of the red component image or varied in accordance with a welding status. When the visual sensor 40 is a surveillance camera fixed at a position, for example, a welding position changes, that is, a distance between a position of the visual sensor 40 and the welding position, a shooting direction, or a shooting angle changes, and size of a shooting target accordingly changes. A relationship between the distance, the direction, and size of a target may be provided in advance, and the first threshold may be changed on the basis of the relationship. Alternatively, magnification of the camera may be changed such that size of a shooting target remains constant, that is, the first threshold remains constant, even if the distance between the position of the visual sensor 40 and the welding position changes. If the number of pixels in the focused area is smaller than or equal to the first threshold, that is, if a result of S1002 is YES, the process performed by the image division unit 53 proceeds to step S1004. If the number of pixels in the focused area is larger than the first threshold, that is, if the result of S1002 is NO, on the other hand, the process performed by the image division unit 53 proceeds to step S1003.

In S1003, the image division unit 53 determines whether the focused area is located at the center of the image and the largest among the labeled areas. That is, in an ordinary image of welding behavior, arc light is located at the center of the image, and an area of the arc light is the largest in the image. If an obstacle or the like appears in an image, on the other hand, arc light might be absent at the center of the image. In this case, a focused area is handled as noise. FIG. 7 illustrates an example where an image includes an obstacle. In this case, an image where arc light is not located at the center thereof is obtained. The center here may refer to a range set in advance and change in accordance with image size, welding behavior, or the like. The largest in the determination in this step refers to a relative size between a plurality of areas of an image, and differs depending on an image. If the focused area satisfies the above conditions, that is, if a result of S1003 is YES, the process performed by the image division unit 53 proceeds to step S1005. If the focused area does not satisfy the above conditions, on the other hand, that is, if the result of S1003 is NO, the process performed by the image division unit 53 proceeds to step S1006.

In S1004, the image division unit 53 determines whether the focused area is larger than or equal to a second threshold. The second threshold indicates a smallest rectangular area encompassing the focused area and is set as percentage of the number of pixels of the focused area relative to the number of pixels of the rectangular area. The size of the rectangular area, therefore, changes in accordance with the size of each focused area. It is assumed here that the second threshold is 15%. That is, in the determination in this step, whether the following condition is satisfied is determined.

Second threshold≤(Size of focused area)/(Size of rectangular area encompassing focused area)

If the focused area is larger than or equal to the second threshold, that is, if a result of S1004 is YES, the process performed by the image division unit 53 proceeds to S1007. If the focused area is smaller than the second threshold, that is, if the result of S1004 is NO, on the other hand, the process performed by the image division unit 53 proceeds to S1008.

In S1005, the image division unit 53 classifies the focused area as an area of arc light. The process performed by the image division unit 53 then proceeds to S1009.

In S1006, the image division unit 53 classifies the focused area as an area of noise. The process performed by the image division unit 53 proceeds to S1009.

In S1007, the image division unit 53 classifies the focused area as an area of a spatter. The process performed by the image division unit 53 then proceeds to S1009.

In S1008, the image division unit 53 classifies the focused area as an area of thick fumes. The process performed by the image division unit 53 proceeds to S1009.

In S1009, the image division unit 53 determines whether there is an unprocessed area. If there is an unprocessed area, that is, if a result of S1009 is YES, the process performed by the image division unit 53 returns to S1001 and is repeated. If there is no unprocessed area, that is, if the result of S1009 is NO, on the other hand, the processing flow ends, and S811 in FIG. 8 is performed.

Referring back to FIG. 8, an operation for calculating the index value of arc light will be described. In S811, the data processing apparatus 50 generates a binary image including the area classified as arc light through the element classification described with reference to FIG. 10. The binary image may be generated by extracting the area classified as arc light from the binary image labeled in S809. The binary image at this time includes an element corresponding to flare. Flare is light caused as a result of reflection by a lens included in the visual sensor 40 or reflection inside the camera.

The data processing apparatus 50, therefore, performs, using the image division unit 53, erosion and dilation on the generated binary image in order to remove the element of flare. A known method may be used for the erosion and dilation. The erosion and dilation may be performed a plurality of times in order to remove the element of flare appropriately, and order of processing is not particularly limited.

In S812, the data processing apparatus 50 calculates, using the calculation unit 54, the index value of arc light using the binary image processed in S811. The calculation unit 54 counts the number of pixels in the area of arc light included in the binary image and uses the value as the index value.

The index value of arc light based on luminance values is calculated in the processing in S806, and the index value of arc light based on the number of pixels is calculated in the processing in S812. These may be handled as separate index values, or a single index value of the entirety of arc light may be obtained from the two index values. Arc width, arc length, and a direction of arc deflection may also be calculated for the index value of arc light on the basis of area, a center of gravity, and an angle of a main axis in the area of arc light.

Next, an operation for calculating an index value of spatters will be described. In S813, the data processing apparatus 50 generates, using the image processing unit 52 and the red component image processed in S807, a red component image including areas of spatters classified in the element classification illustrated in FIG. 10.

In S814, the data processing apparatus 50 calculates the index value of spatters using the calculation unit 54 and the red component image generated in S813. First, the calculation unit 54 removes, among the areas of spatters included in the red component image, areas larger than or equal to a certain threshold, that is, areas including the number of pixels larger than or equal to a certain threshold. Because it is assumed that each spatter is smaller than a certain size, the areas are regarded as backgrounds and removed. The threshold is not particularly limited, but is set in advance. Next, the calculation unit 54 identifies remaining areas of spatters and calculates the number of pixels included in the areas and the number of areas including the identified pixels as the index value of spatters. At this time, only pixels whose R values are larger than or equal to a certain threshold may be counted in order to count the number of pixels.

In order to calculate an evaluation value here, correspondences between the measured number of spatters caused and values calculated from images according to the present embodiment may be defined in advance using relational expressions or a table, and the index value may be obtained using these. In this case, a value calculated from an image may be converted into the number of spatters indicating weight in unit time using the relational expressions or the table.

Next, an operation for calculating the index value of thick fumes will be described. In S815, the data processing apparatus 50 generates an image from which spatters have been removed by subtracting, using the image processing unit 52, values of the areas of spatters generated in S813 from the image generated in S807.

In S816, the data processing apparatus 50 performs, using the image processing unit 52, gamma correction on the image generated in S815. By converting luminance values through the gamma correction, areas in the image with minute luminance values are excluded. A threshold used for areas to be excluded is not particularly limited and is set in advance. A known method may be used for the gamma correction, and the configuration of a gamma curve, for example, is not particularly limited.

In S817, the data processing apparatus 50 filters, using the image processing unit 52, the image processed in S816. As a result of the filtering, edges in the image are detected, and parts with steep gradients in luminance values are highlighted. A Laplacian filter, for example, may be used for the filtering, but another filter may be used, instead.

In S818, the data processing apparatus 50 performs, using the image processing unit 52, area division based on gradients of luminance on the image filtered in S817. The area division is performed, for example, using a watershed algorithm. With the watershed algorithm, parts where differences in luminance, that is, gradients of shades, are large can be further divided and highlighted. A method of area division used is not particularly limited, and another method may be used, instead.

In S819, the data processing apparatus 50 calculates, using the calculation unit 54, the index value of thick fumes on the basis of the image generated in S818. In the processing in S818, the image is divided into a plurality of sub-areas. At this time, shades are deeper in smaller sub-areas. In the present embodiment, areas with deep shades, that is, sub-areas smaller than or equal to a predetermined area, are determined as parts where thick fumes have occurred, and a total value of area is assumed as the index value of thick fumes. In the present embodiment, the index value of thick fumes is obtained using the following expression (1). In the following expression (1), Tₙ denotes area of a sub-area n, that is, the number of pixels (n=1, . . . , or i)

$$\begin{matrix}[ Math . 1 ] & \\ ( Index value of thick fumes ) = \sum \frac{1}{log ( {T}_{n} )} & ( 1 )\end{matrix}$$

In order to calculate the evaluation value here, correspondences between measured area of fumes caused and values calculated from images according to the present embodiment may be defined in advance using relational expressions, a table, or the like, and the index value may be calculated using these. In this case, the values measured from the images may be converted into the amount of fumes indicating weight in unit time using the relational expressions or the table.

The index value of thin fumes is calculated in the processing in S804, and the index value of thick fumes is calculated in the processing in S819. These may be handled as separate index values, or a single index value of both types of fumes may be obtained from the two index values using a certain conversion expression.

After obtaining the above index values, the data processing apparatus 50 displays, using the display unit 56, the index values on a screen that is not illustrated. At this time, a plurality of types of welding behavior, such as spatters and fumes, identified by the calculated index values may be displayed in a time series, and not only the results of the calculation of the index values of the types of welding behavior but also the welding current and the arc voltage may be synchronized with one another and displayed next to one another so that targets to be compared with each other can be easily recognized visually.

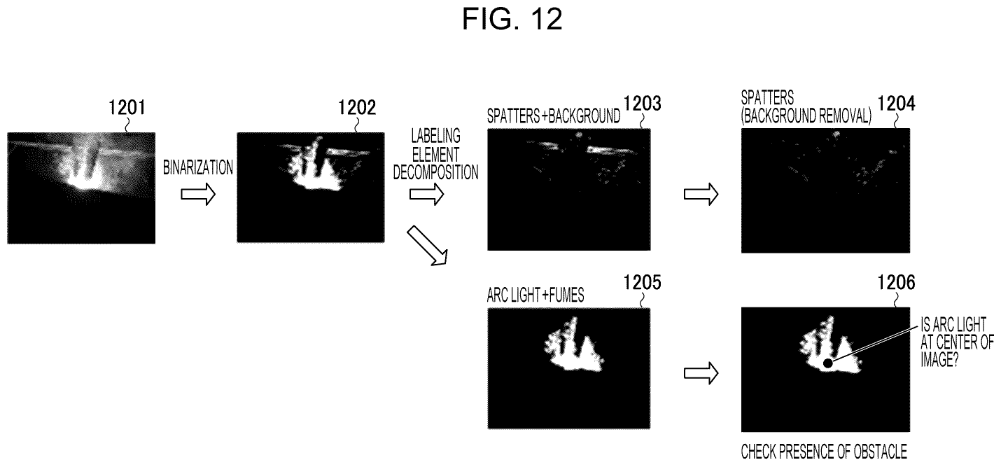

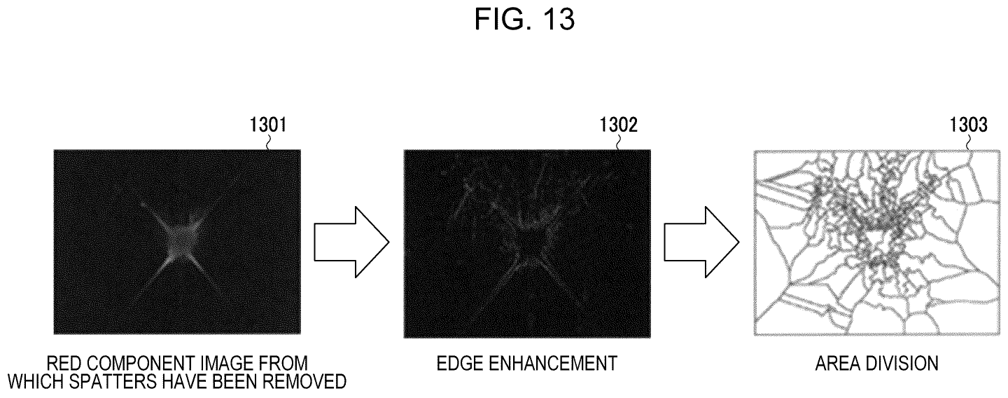

FIGS. 12 and 13 are diagrams illustrating how images change through the image processing in the above process. FIG. 12 illustrates how a red component image changes until images for different elements are generated and corresponds to the image processing performed in the processing in S805 to S815 in the processing sequence illustrated in FIG. 8.

An image 1201 is an example of the red component image and an image subjected to the color component decomposition. An image 1202 is an image obtained by binarizing the image 1201. The images 1203 and 1205 are images generated for different elements by employing the labeling and the element decomposition for the image 1202. An image 1203 is an image including areas classified as spatters and corresponds to the image generated in S811. An image 1205 is an image including an area classified as arc light and corresponds to the image generated in S815.

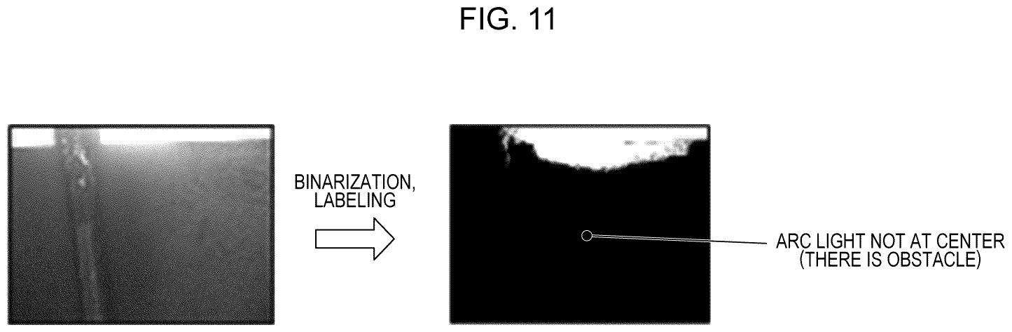

An image 1204 is an image obtained by removing areas regarded as backgrounds from the image 1203 and corresponds to the image generated in S814. An image 1206 indicates a case where no obstacle appears in the image 1205. If an obstacle appears as illustrated in FIG. 11, an area classified as arc light is absent at the center of the image. In the image 1206, on the other hand, an area classified as arc light is absent at the center of the image.

FIG. 13 illustrates how a red component image changes until the area division and corresponds to the image processing performed in the processing in S815 to S818 in the processing sequence illustrated in FIG. 8.

An image 1301 is an example of the red component image from which areas of spatters have been removed and corresponds to the image generated in S815. An image 1302 is an image obtained by employing the gamma correction and the filtering for the image 1301 and corresponds to the image processed in S817. An image 1303 is an image obtained by employing the area division for the image 1302 and corresponds to the image processed in S818.

As indicated by the procedure from S802 to S805 and S808 in FIG. 8, the color processing, the background subtraction (processing relating to smoothness), and the binarization are preferably performed in this order. As a result, areas of welding behavior included in an image can be appropriately detected.

As described above, according to the present embodiment, an operator can promptly recognize a plurality of pieces of welding-related information and easily obtain useful information in order to solve more advanced problems relating to welding. In particular, a plurality of items can be compared with each other and a welding status can be easily recognized.

### Other Embodiments

In the above configuration, measurement time may also be settable. In moving image data having a certain length of time, for example, a time period where the moving image data is measured may be specified. In the time period, pixels and luminance values of fumes, spatters, and arc light may be counted, and index values may be calculated. As a result, for example, welding behavior can be checked in consideration of welding conditions in a certain time period.

In the above configuration, the operation of the welding robot 10, the power supply apparatus 30, and the visual sensor 40 may be controlled on the basis of results of the measurement and the error checks. For example, the shooting settings of the visual sensor 40 may be changed, or various welding parameters of the welding robot 10 and the power supply apparatus 30 may be controlled. As a result, for example, the welding robot 10 can be operated more appropriately in accordance with occurrence conditions of welding behavior.

The invention in the present application can also be implemented through a process where a program or an application for achieving one or more functions in the above-described embodiments is supplied to a system or an apparatus using a network, a storage medium, or the like and one or more processors of a computer of the system or the apparatus read and execute the program.

The invention in the present application may be implemented by a circuit for achieving one or more functions. The circuit for achieving one or more functions is, for example, an ASIC (application-specific integrated circuit) or an FPGA (field-programmable gate array).

As described above, the following items are disclosed herein.
(1) A method for displaying welding-related information, the method including:
a display step of displaying at least two of a plurality of measurement items included in the welding-related information on a same graph while associating the at least two measurement items with at least a time series or positional information,
in which each of the at least two measurement items is displayed on the graph with a color or a line type of the measurement item changed,
in which a display screen for the graph and at least a display screen for a moving image of welding associated with the measurement items displayed on the graph or a display screen for history information regarding errors detected with respect to the measurement items are switchable, and
in which the welding-related information includes at least welding setting information, welding state information, production condition information, correction information, or welding phenomenon information.

With this configuration, an operator can promptly recognize a plurality of pieces of welding-related information and easily obtain useful information in order to solve more advanced problems relating to welding.
(2) The method according to (1),
in which at least two of fluctuation trends including an increase, a decrease, and no change are indicated with a sign or a figure for fluctuation trends, in terms of time or position, of the at least two measurement items displayed on the graph.

With this configuration, fluctuation trends of a plurality of measurement items can be easily recognized on a single screen.
(3) The method according to (2),
in which the figure is an arrow, whose direction indicates an increase, a decrease, or no change and whose color, tone, or size indicates an amount of change.

With this configuration, fluctuation trends of a plurality of measurement items can be easily recognized visually on a single screen.
(4) The method according to claim 2 or 3,
in which the fluctuation trends of the measurement items are determined on a basis of values of at least two points near a focused sampling point in time or position.

With this configuration, fluctuation trends can be determined on the basis of values near a focused sampling point.
(5) The method according to any of (1) to (4),
in which values of the measurement items and at least past data or reference data regarding the measurement items are displayed while being associated with each other.

With this configuration, a result of evaluation of measured values performed on the basis of past data and reference data can be easily recognized.
(6) The method according to any of (1) to (5),
in which values of the measurement items and results of a determination process performed on a basis of past data, reference data, or setting values of the measurement items are displayed while being associated with each other.

With this configuration, a result of a determination made on the basis of past data, reference data, or setting values can be easily recognized.
(7) The method according to (6),
in which, if a certain determination is made in the determination process, at least a color or a line type is changed on the graph within a range indicating a measurement item subjected to the certain determination.

With this configuration, a result can be easily recognized visually by changing a color or a line type on the basis of a result of the determination process.
(8) The method according to any of (1) to (7),
in which the at least two measurement items are selected from at least two of the welding setting information, the welding state information, the production condition information, the correction information, and the welding phenomenon information included in the welding-related information.

With this configuration, measurement items can be selected and displayed from a plurality of pieces of information.
(9) The method according to any of (1) to (8),
in which a measurement item relating to the welding setting information includes a setting value of at least welding current, arc voltage, feed speed, welding speed, a shield gas flow rate, or shield gas pressure.

With this configuration, a plurality of setting values are displayed on a display screen as welding setting information.
(10) The method according to any of (1) to (9),
in which a measurement item relating to the welding state information includes a detected value of at least welding current, arc voltage, feed speed, welding speed, a shield gas flow rate, or shield gas pressure.

With this configuration, a plurality of detected values can be displayed on a display screen as welding state information.
(11) The method according to any of (1) to (10),
in which a measurement item relating to the production condition information includes a detected value of at least wire consumption, a wire consumption rate, arc percentage, a feed load, and a number of short circuits.

With this configuration, a plurality of detected values are displayed on a display screen as production condition information.
(12) The method according to any of (1) to (11),
in which a measurement item relating to the correction information includes a detected value of at least an amount of sensing correction or an amount of arc sensor correction.

With this configuration, a plurality of detected values can be displayed on a display screen as correction information.
(13) The method according to any of (1) to (12),
in which a measurement item relating to the welding phenomenon information includes a detected value of at least a spatter, fumes, arc length, arc width, a welding defect, molten pool width, molten pool height, or temperature of a molten pool or a droplet.

With this configuration, a plurality of detected values can be displayed on a display screen as welding phenomenon information.
(14) The method according to any of claims (1) to (13),
in which a measurement item of at least a spatter, fumes, arc length, arc width, a welding defect, molten pool width, molten pool height, or temperature of a molten pool or a droplet is displayed on the display screen as the welding phenomenon information.

With this configuration, at least a spatter, fumes, arc length, arc width, a welding defect, molten pool width, molten pool height, or temperature of a molten pool or a droplet can be displayed on a display screen as a measurement item of welding phenomenon information.
(15) A display apparatus that displays welding-related information, the display apparatus including:
display means for displaying at least two of a plurality of measurement items included in the welding-related information on a same graph while associating the at least two measurement items with at least a time series or positional information,
in which each of the at least two measurement items is displayed on the graph with a color or a line type of the measurement item changed,
in which a display screen for the graph and at least a display screen for a moving image of welding associated with the measurement items displayed on the graph or a display screen for history information regarding errors detected with respect to the measurement items are switchable, and
in which the welding-related information includes at least welding setting information, welding state information, production condition information, correction information, or welding phenomenon information.

With this configuration, an operator can promptly recognize a plurality of pieces of welding-related information and easily obtain useful information in order to solve more advanced problems relating to welding.
(16) A welding system including:
a welding apparatus;
a sensor;
a measurement apparatus that measures welding-related information using a value detected by the sensor; and
a display apparatus that displays the welding-related information,
in which the display apparatus includes
display means for displaying at least two of a plurality of measurement items included in the welding-related information on a same graph while associating the at least two measurement items with at least a time series or positional information,
in which each of the at least two measurement items is displayed on the graph with a color or a line type of the measurement item changed,
in which a display screen for the graph and at least a display screen for a moving image of welding associated with the measurement items displayed on the graph or a display screen for history information regarding errors detected with respect to the measurement items are switchable, and
in which the welding-related information includes at least welding setting information, welding state information, production condition information, correction information, or welding phenomenon information.

With this configuration, an operator can promptly recognize a plurality of pieces of welding-related information and easily obtain useful information in order to solve more advanced problems relating to welding.
(17) A method for displaying deposition-related information, the method including:
a display step of displaying at least two of a plurality of measurement items included in the deposition-related information on a same graph while associating the at least two measurement items with at least a time series or positional information,
in which each of the at least two measurement items is displayed on the graph with a color or a line type of the measurement item changed,
in which a display screen for the graph and at least a display screen for a moving image of deposition associated with the measurement items displayed on the graph or a display screen for history information regarding errors detected with respect to the measurement items are switchable, and
in which the deposition-related information includes at least deposition setting information, deposition state information, production condition information, correction information, or deposition phenomenon information.

With this configuration, an operator can promptly recognize a plurality of pieces of welding-related information and easily obtain useful information in order to solve more advanced problems relating to welding.
(18) A program causing a computer to perform a process including:
a display step of displaying at least two of a plurality of measurement items included in welding-related information on a same graph while associating the at least two measurement items with at least a time series or positional information,
in which each of the at least two measurement items is displayed on the graph with a color or a line type of the measurement item changed,
in which a display screen for the graph and at least a display screen for a moving image of welding associated with the measurement items displayed on the graph or a display screen for history information regarding errors detected with respect to the measurement items are switchable, and
in which the welding-related information includes at least welding setting information, welding state information, production condition information, correction information, or welding phenomenon information.

With this configuration, an operator can promptly recognize a plurality of pieces of welding-related information and easily obtain useful information in order to solve more advanced problems relating to welding.
(19) A display screen for welding-related information generated in a display step of displaying at least two of a plurality of measurement items included in the welding-related information on a same graph while associating the at least two measurement items with at least a time series or positional information,
in which each of the at least two measurement items is displayed on the graph with a color or a line type of the measurement item changed,
in which a display screen for the graph and at least a display screen for a moving image of welding associated with the measurement items displayed on the graph or a display screen for history information regarding errors detected with respect to the measurement items are switchable, and
in which the welding-related information includes at least welding setting information, welding state information, production condition information, correction information, or welding phenomenon information.

With this configuration, an operator can promptly recognize a plurality of pieces of welding-related information and easily obtain useful information in order to solve more advanced problems relating to welding.

Although various embodiments have been described with reference to the drawings, it is needless to say that the present invention is not limited to these examples. It is obvious that those skilled in the art can arrive at various modifications or corrections within the scope of the claims, and such modifications and corrections should be understood to belong to the technical scope of the present invention. The components in the above embodiments may be combined in any manner without deviating from the scope of the invention.

The present application is based on a Japanese patent application (Japanese Patent Application No. 2021-118758) filed on Jul. 19, 2021, the entire contents of which are incorporated herein by reference.

### REFERENCE SIGNS LIST

1 welding system
10 welding robot
11 welding torch
12 wire feeding apparatus
13 welding wire
20 robot control apparatus
30 power supply apparatus
40 visual sensor
41 laser sensor
42 current sensor
43 voltage sensor
50 data processing apparatus
51 storage unit
52 image processing unit
53 image division unit
54 calculation unit
55 display control unit
56 display unit
57 sensor control unit
201 CPU (central processing unit)
202 memory
202A control program
203 operation panel
204 teaching pendant
205 robot connection unit
206 communication unit

1. A method for displaying welding-related information, the method comprising:
a display step of displaying at least two of a plurality of measurement items included in the welding-related information on a same graph while associating the at least two measurement items with at least a time series or positional information,
wherein each of the at least two measurement items is displayed on the graph with a color or a line type of the measurement item changed,
wherein a display screen for the graph and at least a display screen for a moving image of welding associated with the measurement items displayed on the graph or a display screen for history information regarding errors detected with respect to the measurement items are switchable, and
wherein the welding-related information includes at least welding setting information, welding state information, production condition information, correction information, or welding phenomenon information.

2. The method according to claim 1,
wherein at least two of fluctuation trends including an increase, a decrease, and no change are indicated with a sign or a figure for fluctuation trends, in terms of time or position, of the at least two measurement items displayed on the graph.

3. The method according to claim 2,
wherein the figure is an arrow, whose direction indicates an increase, a decrease, or no change and whose color, tone, or size indicates an amount of change.

4. The method according to claim 2,
wherein the fluctuation trends of the measurement items are determined on a basis of values of at least two points near a focused sampling point in time or position.

5. The method according to claim 1,
wherein values of the measurement items and at least past data or reference data regarding the measurement items are displayed while being associated with each other.

6. The method according to claim 1,
wherein values of the measurement items and results of a determination process performed on a basis of past data, reference data, or setting values of the measurement items are displayed while being associated with each other.

7. The method according to claim 6,
wherein, if a certain determination is made in the determination process, at least a color or a line type is changed on the graph within a range indicating a measurement item subjected to the certain determination.

8. The method according to claim 1,
wherein the at least two measurement items are selected from at least two of the welding setting information, the welding state information, the production condition information, the correction information, and the welding phenomenon information included in the welding-related information.

9. The method according to claim 1,
wherein a measurement item relating to the welding setting information includes a setting value of at least welding current, arc voltage, feed speed, welding speed, a shield gas flow rate, or shield gas pressure.

10. The method according to claim 1,
wherein a measurement item relating to the welding state information includes a detected value of at least welding current, arc voltage, feed speed, welding speed, a shield gas flow rate, or shield gas pressure.

11. The method according to claim 1,
wherein a measurement item relating to the production condition information includes a detected value of at least wire consumption, a wire consumption rate, arc percentage, a feed load, and a number of short circuits.

12. The method according to claim 1,
wherein a measurement item relating to the correction information includes a detected value of at least an amount of sensing correction or an amount of arc sensor correction.

13. The method according to claim 1,
wherein a measurement item relating to the welding phenomenon information includes a detected value of at least a spatter, fumes, arc length, arc width, a welding defect, molten pool width, molten pool height, or temperature of a molten pool or a droplet.

14. The method according to claim 1,
wherein a measurement item of at least a spatter, fumes, arc length, arc width, a welding defect, molten pool width, molten pool height, or temperature of a molten pool or a droplet is displayed on the display screen as the welding phenomenon information.

15. A display apparatus that displays welding-related information, the display apparatus comprising:
display means for displaying at least two of a plurality of measurement items included in the welding-related information on a same graph while associating the at least two measurement items with at least a time series or positional information,
wherein each of the at least two measurement items is displayed on the graph with a color or a line type of the measurement item changed,
wherein a display screen for the graph and at least a display screen for a moving image of welding associated with the measurement items displayed on the graph or a display screen for history information regarding errors detected with respect to the measurement items are switchable, and
wherein the welding-related information includes at least welding setting information, welding state information, production condition information, correction information, or welding phenomenon information.

16. A welding system comprising:
a welding apparatus;
a sensor;
a measurement apparatus that measures welding-related information using a value detected by the sensor; and
a display apparatus that displays the welding-related information,
wherein the display apparatus includes
display means for displaying at least two of a plurality of measurement items included in the welding-related information on a same graph while associating the at least two measurement items with at least a time series or positional information,
wherein each of the at least two measurement items is displayed on the graph with a color or a line type of the measurement item changed,
wherein a display screen for the graph and at least a display screen for a moving image of welding associated with the measurement items displayed on the graph or a display screen for history information regarding errors detected with respect to the measurement items are switchable, and
wherein the welding-related information includes at least welding setting information, welding state information, production condition information, correction information, or welding phenomenon information.

17. A method for displaying deposition-related information, the method comprising:
a display step of displaying at least two of a plurality of measurement items included in the deposition-related information on a same graph while associating the at least two measurement items with at least a time series or positional information,
wherein each of the at least two measurement items is displayed on the graph with a color or a line type of the measurement item changed,
wherein a display screen for the graph and at least a display screen for a moving image of deposition associated with the measurement items displayed on the graph or a display screen for history information regarding errors detected with respect to the measurement items are switchable, and
wherein the deposition-related information includes at least deposition setting information, deposition state information, production condition information, correction information, or deposition phenomenon information.

18. A non-transitory computer readable medium storing a program that, when executed by a computer, causes the computer to perform a process comprising:
a display step of displaying at least two of a plurality of measurement items included in welding-related information on a same graph while associating the at least two measurement items with at least a time series or positional information,
wherein each of the at least two measurement items is displayed on the graph with a color or a line type of the measurement item changed,
wherein a display screen for the graph and at least a display screen for a moving image of welding associated with the measurement items displayed on the graph or a display screen for history information regarding errors detected with respect to the measurement items are switchable, and
wherein the welding-related information includes at least welding setting information, welding state information, production condition information, correction information, or welding phenomenon information.

19. A display screen for welding-related information generated in a display step of displaying at least two of a plurality of measurement items included in the welding-related information on a same graph while associating the at least two measurement items with at least a time series or positional information,
wherein each of the at least two measurement items is displayed on the graph with a color or a line type of the measurement item changed,
wherein a display screen for the graph and at least a display screen for a moving image of welding associated with the measurement items displayed on the graph or a display screen for history information regarding errors detected with respect to the measurement items are switchable, and
wherein the welding-related information includes at least welding setting information, welding state information, production condition information, correction information, or welding phenomenon information.
